(19) United States
(12) Patent Application Publication
(10) Pub. No.: US 2009/0019061 A1
(43) Pub. Date: Jan. 15, 2009

(54) PROVIDING INFORMATION TO A USER

(75) Inventor: Robert F. Scannell, JR., Lebanon, NJ (US)

Correspondence Address: FISH & RICHARDSON PC, P.O. BOX 1022, MINNEAPOLIS, MN, 55440-1022, US

(73) Assignee: INSIGNIO TECHNOLOGIES, INC., Lebanon, NJ (US)

(21) Appl. No.: 12/179,547

(22) Filed: Jul. 24, 2008

Related U.S. Application Data
(63) Continuation-in-part of application No. 11/291,384, filed on Dec. 1, 2005.
Application No. 11/291,384 is a continuation-in-part of application No. 11/218,948, filed on Sep. 2, 2005.
Application No. 11/291,384 is a continuation-in-part of application No. 11/062,039, filed on Feb. 18, 2005.
Application No. 11/291,384 is a continuation-in-part of application No. 11/101,066, filed on Apr. 7, 2005, now abandoned.
(60) Provisional application No. 60/951,539, filed on Jul. 24, 2007.
(60) Provisional application No. 60/632,643, filed on Dec. 2, 2004.
(60) Provisional application No. 60/607,961, filed on Sep. 8, 2004.
(60) Provisional application No. 60/545,939, filed on Feb. 20, 2004.
(60) Provisional application No. 60/560,908, filed on Apr. 10, 2004.

(51) Int. Cl. G06F 17/30; G06F 15/16

(52) U.S. Cl. 707/10; 709/203; 707/E17.032

(57) ABSTRACT

Providing information to a user includes: associating a code with content that is available to multiple users; storing data that associates information with the code; receiving the code from a user input received over a communications channel from a communications device; determining an identifier associated with the communications device from which the code was received; and providing the information associated with the code for access on at least a portion of a web site provided based on an association between the user and the determined identifier.

### CROSS-REFERENCE TO RELATED APPLICATIONS

This application claims priority to U.S. Application Ser. No. 60/951,539, entitled “PROVIDING INFORMATION TO A USER,” filed on Jul. 24, 2007, incorporated herein by reference, and this application is a continuation-in-part of U.S. application Ser. No. 11/291,384, entitled “PERSONALIZED CONTENT PROCESSING AND DELIVERY SYSTEM AND MEDIA,” filed on Dec. 1, 2005, incorporated herein by reference, which claims priority to U.S. Application Ser. No. 60/632,643, entitled “PERSONALIZED CONTENT PROCESSING & DELIVERY SYSTEM AND MEDIA,” filed on Dec. 2, 2004, incorporated herein by reference.

U.S. application Ser. No. 11/291,384 is a continuation-in-part of U.S. Ser. No. 11/062,039, entitled “MULTIFUNCTION-ADAPTABLE, MULTICOMPONENT DEVICES,” filed on Feb. 18, 2005, incorporated herein by reference, which claims priority to U.S. Application Ser. No. 60/545,939, entitled, “Lighting Fixture, Switch Assembly and Enclosure With Interconnecting, Interchangeable and Modular Components,” filed on Feb. 20, 2004, incorporated herein by reference.

U.S. application Ser. No. 11/291,384 is also a continuation-in-part of U.S. application Ser. No. 11/101,066, entitled “MULTIFUNCTION-CAPABLE HEALTH RELATED DEVICES,” filed on Apr. 7, 2005, incorporated herein by reference, which claims priority to U.S. Application Ser. No. 60/560,908, entitled “Multi-utility fixtures, enclosures, pedestals, and bases with interchangeable, modular, integrated and/or networked components,” filed on Apr. 10, 2004, incorporated herein by reference.

U.S. application Ser. No. 11/291,384 is also a continuation-in-part of U.S. application Ser. No. 11/218,948, entitled “MEDICAL AND HEALTH, ENVIRONMENTAL, AND SECURITY MONITORING ALERT, INTERVENTION, INFORMATION AND NETWORK SYSTEM WITH ASSOCIATED AND SUPPORTING APPARATUSES,” filed on Sep. 2, 2005, incorporated herein by reference, which claims priority to U.S. Application Ser. No. 60/607,961, entitled, “Medical & health, environmental, and security monitoring, alert, intervention, information network system,” filed on Sep. 8, 2004, incorporated herein by reference.

### TECHNICAL FIELD

The invention relates to providing information to a user.

### BACKGROUND

A variety of devices can be used to provide information to users over a network. For example, wireless devices can be used to enable a user to interact with a server by sending requests for specific information (e.g., using links of a browser) and receiving the requested information. Some protocols, such as short message service (SMS), send information to a user's device based on a code (e.g., an SMS short code). The device typically has both communications circuitry to enable the device to interact with and receive information from a server over a communications channel, and an interface that includes components, such as a screen and speaker, that make the device suitable for presenting the information from the server to the user.

### SUMMARY

In one aspect, in general, a method for providing information to a user, includes associating a code with content that is available to multiple users; storing data that associates information with the code; receiving the code from a user input received over a communications channel from a communications device; determining an identifier associated with the communications device from which the code was received; and providing the information associated with the code for access on at least a portion of a web site provided based on an association between the user and the determined identifier.

Aspects can include one or more of the following features.

The medium over which the content is available to the multiple users is selected from the group consisting of print, television, radio, recorded video, and recorded audio.

The information associated with the code comprises digital content associated with the content.

Providing the information associated with the code to the user comprises storing a digital content identifier that enables the information to be retrieved in response to a request from the user.

The method further comprises receiving a request from the user, retrieving the information according to the stored digital content identifier, and providing the information to the user as digital content.

The request from the user is received over the communications channel over which the information associated with the code is provided to the user.

The request from the user comprises data sent from a computer accessible to the user.

The digital content is transmitted to the computer.

The data sent from the computer comprises information selecting a link on a web page.

The data sent from the computer comprises information from a cookie stored on the computer.

The digital content identifier defines at least a portion of a web site associated with the user that includes the information.

The digital content identifier comprises a hyperlink included in the web site associated with the user that links to the information.

The digital content identifier comprises a link to the digital content and an indication of a media player in which the digital content is to be played.

The digital content identifier further comprises an activation function associated with the presentation of the digital content on the media player.

Providing the information associated with the code to the user comprises storing a request for a person to contact the user to provide the information.

The request includes contact information associated with the user.

The contact information comprises the identifier associated with the communications device.

The content comprises a real estate advertisement and the information associated with the code comprises real estate information

Associating the code with the content comprises including the code within the content.

The method further comprises associating different respective codes with different content that is available to multiple users.

The method further comprises storing data that associates different respective information with different codes.

The method further comprises associating the same code with different content that is available to multiple users at different respective times and/or different respective locations.

The time and/or location comprises at least one of time of day, day of week, city, zip code, global positioning system (GPS) coordinates, and event.

The method further comprises storing data that associates different respective information with the same code according to time and/or location at which the associated content was available.

The information provided to the user is based on a correlation between the time of day at which the associated content was available and a time of day at which the user input was received.

The information provided to the user is based on a location received from the device.

The information provided to the user is based on a location determined based signals received from the device.

The method further comprises storing user profile information associated with the user.

Providing the information associated with the code to the user comprises providing information to at least one different user based on the user profile information.

Providing information to at least one different user based on the user profile information comprises providing the information based on an association between the user profile information associated with the user and user profile information associated with the different user.

At least some of the user profile information being received from the user.

The user profile information includes the identifier associated with the communications device.

The method further comprises providing at least one advertisement to the user in response to receiving the code.

The advertisement is provided to the user based on the user profile information.

The advertisement is provided to the user based on the location information associated with the communications device.

The method further comprises receiving over the communications channel from the communications device information indicating which user profile of multiple user profiles includes the stored user profile information associated with the user.

The user profile information includes instructions to process and store the information associated with the code in a designated manner for retrieval by the user.

The instructions include processing and storing the information for retrieval as at least one of email, audio recording, video recording, voice mail, web content, SMS, MMS, instant message, podcast, and videocast.

The method further comprises initiating a transaction based on the association between the user and the determined identifier.

The information associated with the code comprises information about the initiated transaction.

The content comprises advertising.

The content comprises a radio advertisement.

The communications device comprises a mobile device.

The communications device comprises a cell phone.

The identifier associated with the communications device comprises a telephone number associated with the cell phone.

Receiving the code from the user input through the communications device comprises receiving the code over a telephone call initiated from the cell phone.

The telephone call comprises a call to a telephone number associated with a medium over which the content was available to the user.

The medium comprises an audio transmission medium (e.g., radio) and the telephone number associated with the medium comprises a telephone number associated with a provider (e.g., a radio station) from which the content was available.

The medium comprises a video transmission medium (e.g., television) and the telephone number associated with the medium comprises a telephone number associated with a provider (e.g., a television station) from which the content was available.

The medium comprises a print medium and the telephone number associated with the medium comprises a telephone number associated with a distributor from which the content was available

The telephone call comprises a call to an operator.

The method further comprises recording an interaction with the user associated with the received code.

Recording the interaction comprises storing tracking data associated with the interaction.

The method further comprises filtering the tracking data.

In another aspect, in general, a method for providing information to a user includes associating a code with content that is available to multiple users; storing data that associates information with the code; receiving the code over a communications channel from a communications device; determining an identifier associated with the communications device from which the code was received; and providing the information associated with the code to the user over a communications channel from a live person based on the determined identifier.

Aspects can include one or more of the following features.

The live person can be associated with an entity from which the content is available.

The method further comprises recording an interaction with the user associated with the received code.

Recording the interaction comprises storing tracking data associated with the interaction.

The method further comprises filtering the tracking data.

In another aspect, in general, a method for providing information to a user, includes associating a code with content that is available to multiple users; storing data that associates information with the code; receiving the code and a command associated with the code over a communications channel from a communications device; determining an identifier associated with the communications device from which the code was received; and providing the information associated with the code to the user based on an association between the user and the determined identifier.

Aspects can include one or more of the following features.

The medium over which the content is available to the multiple users is selected from the group consisting of print, television, radio, and multimedia stream.

The content available to the multiple users is provided to the multiple users in response to different respective requests from the multiple users.

The content available to the multiple users is provided to the user over a communications channel that is the same as the communications channel over which the code was received.

The content available to the multiple users is provided to the user over a communications channel that is different from the communications channel over which the code was received.

The information associated with the code comprises digital content associated with the content.

Providing the information associated with the code to the user comprises storing a digital content identifier that enables the information to be retrieved in response to a request from the user.

The method further comprises receiving a request from the user, retrieving the information according to the stored digital content identifier, and providing the information to the user as digital content.

The request from the user is received over a communications channel over which the information associated with the code is provided to the user.

The request from the user comprises data sent from a computer accessible to the user.

The digital content is transmitted to the computer.

The data sent from the computer comprises information selecting a link on a web page.

The data sent from the computer comprises information from a cookie stored on the computer.

The digital content identifier defines at least a portion of a web site associated with the user that includes the information.

The digital content identifier comprises a hyperlink included in the web site associated with the user that links to the information.

The digital content identifier comprises a link to the digital content and an indication of a media player in which the digital content is to be played.

The digital content identifier further comprises an activation function associated with the presentation of the digital content on the media player.

The command indicates how the information associated with the code is to be processed.

The command indicates a destination to which the information associated with the code is to be sent.

The command indicates a category with which the information associated with the code is to be associated.

The command indicates data to be sent to the device.

Providing the information associated with the code to the user comprises storing a request for a person to contact the user to provide the information.

The request includes contact information associated with the user.

The contact information comprises the identifier associated with the communications device.

The content comprises a real estate advertisement and the information associated with the code comprises real estate information.

Associating the code with the content comprises including the code within the content.

The method further comprises associating different respective codes with different content that is available to multiple users.

The method further comprises storing data that associates different respective information with different codes.

The method further comprises associating the same code with different content that is available to multiple users at different respective times and/or different respective locations.

The time and/or location comprises at least one of time of day, day of week, city, zip code, global positioning system (GPS) coordinates, and event.

The method further comprises storing data that associates different respective information with the same code according to time and/or location at which the associated content was available.

The information provided to the user is based on a correlation between the time of day at which the associated content was available and a time of day at which the code was received.

The information provided to the user is based on a location received from the device.

The information provided to the user is based on a location determined based signals received from the device.

The method further comprises storing user profile information associated with the user.

Providing the information associated with the code to the user comprises providing information to at least one different user based on the user profile information.

Providing information to at least one different user based on the user profile information comprises providing the information based on an association between the user profile information associated with the user and user profile information associated with the different user.

At least some of the user profile information being received from the user.

The user profile information includes the identifier associated with the communications device.

The method further comprises providing at least one advertisement to the user in response to receiving the code.

The advertisement is provided to the user based on the user profile information.

The advertisement is provided to the user based on the location information associated with the communications device.

The method further comprises receiving over the communications channel from the communications device information indicating which user profile of multiple user profiles includes the stored user profile information associated with the user.

The user profile information includes instructions to process and store the information associated with the code in a designated manner for retrieval by the user.

The instructions include processing and storing the information for retrieval as at least one of email, audio recording, video recording, voice mail, web content, SMS, MMS, instant message, podcast, and videocast.

The method further comprises initiating a transaction based on the association between the user and the determined identifier.

The information associated with the code comprises information about the initiated transaction.

The content comprises advertising.

The content comprises a radio advertisement.

The communications device comprises a mobile device.

The communications device comprises a cell phone.

The identifier associated with the communications device comprises a telephone number associated with the cell phone.

Receiving the code and the command associated with the code comprises receiving the code over a telephone call initiated from the cell phone.

The telephone call comprises a call to a telephone number associated with a medium over which the content was available to the user.

The medium comprises an audio transmission medium (e.g., radio) and the telephone number associated with the medium comprises a telephone number associated with a provider (e.g., a radio station) from which the content was available.

The medium comprises a video transmission medium (e.g., television) and the telephone number associated with the medium comprises a telephone number associated with a provider (e.g., a television station) from which the content was available.

The medium comprises a print medium and the telephone number associated with the medium comprises a telephone number associated with a distributor from which the content was available

The telephone call comprises a call to an operator.

The method further comprises recording an interaction with the user associated with the received code.

Recording the interaction comprises storing tracking data associated with the interaction.

The method further comprises filtering the tracking data.

In another aspect, in general, a method for providing information to a user includes embedding a code within content that is available to multiple users; storing data that associates information with the code; receiving the content at a communications device (e.g., a receiver, a radio, tv, set top box, cell phone, remote control, GPS unit, router) and extracting the code from the content; receiving the code over a communications channel from the communications device; and providing the information associated with the code to the user.

Aspects can include one or more of the following features.

The communications device has a network connection.

The communications device is connected to a device with a network connection.

Providing the information associated with the code to the user comprises providing the information based on an association between the user and the determined identifier.

The communications channel is based on the embedded code.

The communications channel is based on the embedded code and a command provided from the communications device.

The code is associated with a perceptible prompt.

The code is associated with a visually perceptible prompt that is presented on a screen.

The code is associated with an audibly perceptible prompt.

The prompt is associated with a command.

The command corresponds to a function that is selected from the group consisting of: call, tag, buy, post, and send.

The information associated with the code is provided by a live person.

The information associated with the code comprises a digital media version of the content.

The content comprises audio content.

The code is embedded within inaudible portions of the audio content.

The content comprises video content.

The code is embedded within portions of the content that are not perceptible when presented to a user.

The code comprises at least one communications address.

The communications address is selected from the group consisting of a telephone number, a URL, a messaging domain code, a server address, and a DNS address.

The messaging domain code is selected from the group consisting of a SMS domain, a voice SMS domain, a MMS domain, and an instant messaging domain.

The code comprises a code selected from the group consisting of a key word, a key term, a numeric sequence, an alpha sequence, a special character sequence and combinations thereof.

The code key word is in more than one language.

The method further comprises extracting the code from the content at the communications device.

The extracting is initiated by the user.

In another aspect, in general, a method for providing information to a user includes associating a code with content in a database; receiving the code over a communications channel from a communications device; determining an identifier associated with the communications device from which the code was received; and providing content from the database associated with the code to the user based on an association between the user and the determined identifier.

Aspects can include one or more of the following features.

The code identifies a person and the content from the database associated with the code comprises contact information for the identified person.

Providing the content from the database associated with the code to the user comprises storing the contact information in association with an account accessible to the user.

The communications device comprises a transmitter that is connected to a sensor.

The sensor is selected from the group consisting of: an accelerometer, a biosensor, an environmental sensor, an olfactory sensor, an optical sensor, a motion detector, and a circuit sensor.

The communications device comprises a transmitter that is connected to a reader.

The reader is selected from the group consisting of: an RFID reader, an optical character reader, a scanner, and a barcode reader.

The content from the database is associated with a military vehicle or a unit assigned to a military vehicle.

The method further comprises recording transmission of the code over the communications channel from the communications device.

The method further comprises recording a location of the communications device at the time the transmission is recorded.

Recording the transmission comprises recording a date and time of the transmission.

The identifier associated with the communications device from which the code was received comprises a location of the communications device at the time of the transmission.

The identifier associated with the communications device from which the code was received comprises a date and time of the transmission.

The communications device has a unique network address.

The identifier associated with the communications device from which the code was received comprises the network address of the communications device.

In another aspect, in general, a system for providing information to a user includes: a server storing data that associates different codes with respective content that is available to multiple users; and a communications device configured to transmit a code received from user input over a first communications channel. The server is configured to determine an identifier associated with the communications device from which the code was received, and to provide the information associated with the code over a second communications channel that is different from the first communications channel for access on at least a portion of a web site provided based on an association between the user and the determined identifier.

Among the many advantages of the invention (some of which may be achieved only in some of its various aspects and implementations) are the following.

The World Wide Web and other communications technology applications have provided the means to facilitate the widespread generation and dissemination of content, including personalized content. Such content includes, for example, targeted advertising generated from a search engine inquiry or user-selected music downloads. Web content can be generated from user device/software information such as cookies to support a variety of applications, for example, from local weather to certain sports and/or financial results based on pre-selected criteria. Visual content can be accessed through a variety of devices such as personal computer, personal digital assistant (PDA) and/or smart phone devices. There are also techniques for integrating and viewing such content through a television or video broadcast. Even when a person has such a device and the device is turned on, accessing or waiting for such information to be accessible through devices such as personal computers, PDAs or cell phones may not provide an efficient way to access certain types of information.

Some implementations of a system for providing information to a user facilitate the user's use of such information in an efficient manner when such user desires such information in the format and frequency he or she desires. For example, a user can arrange to receive or retrieve information at a more convenient time. An example of an application that may provide personalized content in an on-demand context includes use of content code(s) that may enable a user interested in content associated with a radio program, for example, to engage or access the content (e.g., advertising, program, or program service or product content such as a book associated with an author who may be interviewed on the radio program). In this example, the radio program's announcer may communicate to his/her entire listening audience a telephone number associated with the station (e.g., a telephone number of a broadcasting premises, or a telephone number associated with a group of stations or a broadcast company) and content code(s) associated with the program (and in some cases the telephone number can serve as a content code). Upon hearing the number and, potentially, other content codes, the listener can dial the number (or the number may be programmed as a speed-dial contact number). The listener may use a cell phone or other communications device to perform any of a variety of functions (depending on the functionality of the cell phone or communications device). For example, at one functionality level, the listener (device user) may dial, text and/or speak a voice command including the telephone (or text address) number. Upon the connection of the call originated from the cell phone device, a server may capture the ANI and/or a device or user identifier associated with the cell phone and/or user. The identifier may be the input for a server program to generate a user profile search. Some functions may involve the server processing commands associated with a given content code. One of the outputs and/or outcomes (out of many different potential outputs) of the session between the user and the server may enable the user to retrieve program information (e.g., book information, or a book download or book purchase) at a more convenient time.

In some implementations, a content code can represent a request to speak to a live operator or agent that can contact the user at a later time, or immediately upon receipt of the request.

Other features and advantages of the invention will be found in the detailed description, drawings, and claims.

### DESCRIPTION OF DRAWINGS

FIG. 1 is a schematic diagram of a system for providing information to a user.

FIG. 2 is a flowchart of an exemplary procedure for providing information to a user.

FIG. 3 is a diagram of an exemplary media tag format for a military application.

### DETAILED DESCRIPTION

There are a great many possible implementations of the invention, too many to describe herein. Some possible implementations that are presently preferred are described below. It cannot be emphasized too strongly, however, that these are descriptions of implementations of the invention, and not descriptions of the invention, which is not limited to the detailed implementations described in this section but is described in broader terms in the claims.

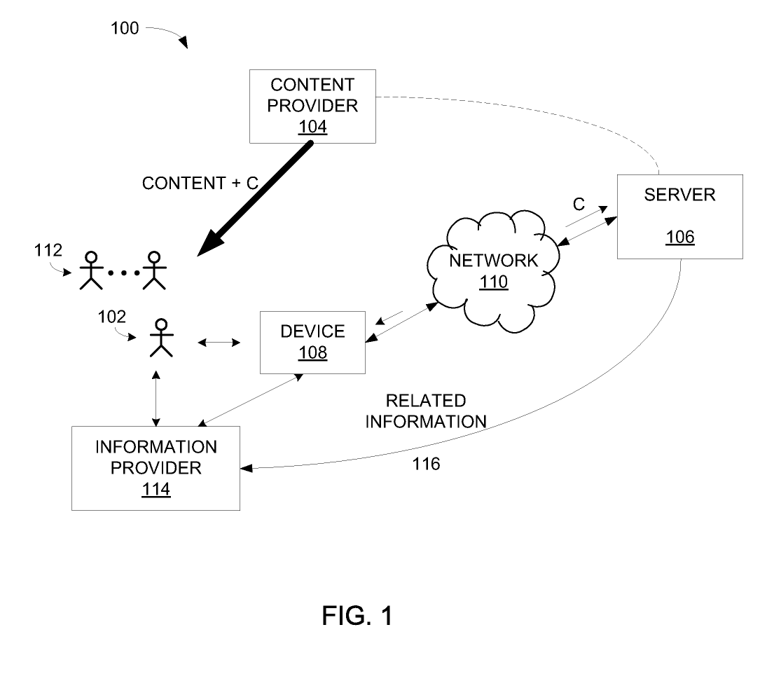

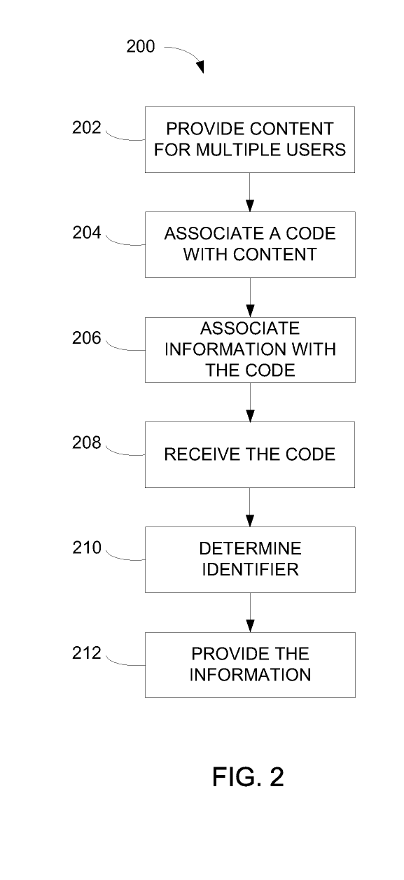

FIG. 1 shows a system 100 for delivering content and providing related information to a user 102, and FIG. 2 shows a procedure 200 for using the system to provide the related information to the user 102. A content provider 104 provides (202) content that is available to multiple users including the user 102 and other users 112 over any of a variety of media. For example, the medium over which the content is available to the multiple users can include print, television, radio, the web, or multimedia stream (e.g., a multimedia stream can include, for example, any one or combination of video, audio, and text, such as an MMS stream or an RSS feed, or any of a variety of media associated with streaming media players). In some cases, the content is broadcast to all the users at the same time. In some cases, the content available to the multiple users is provided to the multiple users potentially at different times, in response to different respective requests from the multiple users (e.g., by downloading the latest entries of an RSS feed).

A server 106 provides information 116 related to the content provided by the content provider 104. In some examples, the server 106 is operated by the content provider 104. In other examples, the server 106 is operated by different entity that may have a business relationship with the content provider 104. The related information 116 can be stored, for example, in a database that associates different content (e.g., print, television or radio programs or advertisements) with corresponding related information that may be of interest to a user. The related information 116 can be in any of a variety of forms. For example, the related information 116 can be digital data encoded as any of a variety of types of media (e.g., audio, video, text). The related information 116 can be information that is communicated verbally from a live person or from a recording. The related information 116 can be provided in the form of a service.

The system 100 enables a user that receives given content from the content provider 104 to request related information 116 using a code (labeled as C in FIG. 1) that is associated (204) with the content (also called a “content code” or “content identifier code”). The server 106 stores data (e.g., in the database) that associates (206) the information related to a given content item with the code for that content item. In some implementations, the code C is not stored explicitly, but information that can be used to match to the code C is stored.

The user 102, after receiving the content, may decide that additional information (including, for example, additional related content or purchasing information) is desired. In some cases, the user 102 may attempt to retrieve additional information related to the content using a portable device. In some cases, the device may not have the capabilities to receive the information, or even if the device does have the capabilities to receive the information, it may not be a convenient time or place to receive the information. The code associated with given content, and distributed with the content, provides a convenient way for the user to request additional information related to the content (e.g., the related information 116), without not necessarily receiving the information at the same time or place. In some cases the code can be implicitly included with the content. For example, the code C is not necessarily explicitly distributed with the content, but the content may include information that can be used to derive the code C (e.g., a bar code can be included in printed content that can be scanned to obtain a numerical code). The code C and/or other information included in the content can be used, for example, to provide the additional information or to activate a communications-based transaction.

In the system 100, the user 102 communicates the code to the server 106 using a portable device 108 (e.g., mobile or handheld computer, mobile phone, media player, television, set-top box, remote control, GPS unit, networked display, integrated automobile device, radio, or device such as a smartphone with various combinations of these or other features). The server 106 and device 108 are in communication over a communications channel through a network 110. The communication infrastructure for the network 110 may include one or more coupled networks such as a data network (e.g., Wi-Fi, the Internet) and/or a telephone network (e.g., Public Switched Telephone Network (PSTN)). The communications channel provides a high layer end-to-end connection that can use any one or more of various types of physical links, including wireless (e.g. spread spectrum), wired, and/or optical links. The user 102 can input the code into the device 108 using any of a variety of interactions including, for example, keypad (e.g., via dual-tone multi-frequency (DTMF) or text), button depression, touch screen, click or motion. The server 106 receives the code (208) over the communications channel. In some implementations of the system 100, the server 106 recognizes the code from a user voice input. In some cases, the content associated with the code may have been provided to the user from the server 106 over the same communications channel over which the code was sent.

A few examples of the wide variety of types of content for which related information 116 can be provided include the following:
a real estate listing
a job listing
an advertisement (e.g., for an automobile, job, travel and leisure, dining, sports, entertainment, health, home/garden, professional services)
business to business marketing collateral

In some cases, the code is received along with a command associated with the code. For example, the command can be used to indicate how the related information 116 is to be processed. The command can indicate a destination to which the related information 116 is to be sent. The command can indicate a category with which the related information 116 is to be associated. The command can indicate data to be sent from the server 106 back to the device 108. For example, data such as a calendar event or contact information can be received and stored on the device. The command can also indicate a web-based application program associated with how the data may be processed. For example, the data may be integrated with a web-based calendar, contact application or a sales contact and customer relationship management (CRM) system program associated with an information provider program based on an association between the command, code and identifier associated with the user's communications device 108, where the identifier may be, for example, the telephone number transmitted during the initial call set-up to server 106 (e.g., using Automatic Number Identification (ANI)). The command can also be associated with a request for a secondary communications connection, such as, for example, a call bridge or transfer wherein a code that comprises a keyword, such as a brand name of an advertiser, activates a program on server 106 for a database retrieval of a telephone number associated with the respective advertiser and a call set-up that directly and conveniently connects the user 102 to a live operator that supports calls for the respective advertiser.

The received code enables the server 106 to prepare the related information 116 to be provided to the user 102 either immediately through a call connection as described above or at a different time or place that may be more convenient for the user. For example, a call connection at a more convenient time may be provided using a click-to-call function or a published 800-number associated with the call center or media provider that placed the associated advertisement (where the respective 800-number may terminate into and bridge with the system 100), where the related information 116 may be conveniently retrieved and activated by the user via his/her communications device or other device (e.g., a PC).

After receiving the code, the server 106 determines (210) an identifier associated with the communications device 108 from which the code was received. The identifier can be, for example, a telephone number of the device 108, or other subscriber information for the user. The server 106 determines an association between the user 102 and the identifier. For example, the user 102 may have previously registered an account accessible to the server 106, providing information that enables the server 106 to look up the user's account based on the phone number from which the code was sent.

After determining the association between the identifier and the user 102, the server 106 prepares the related information 116 for retrieval by the user 102. For example, the server 106 provides (212) the related information 116 to an information provider 114. The information provider 114 may be accessible to the user 102 directly over the device 108, or over a different device and/or communications channel, for example, at a more convenient time or place. The information provider 114 can be, for example, a server accessible to the user 102 via a computer (e.g., any type of desktop or mobile computer) from which the related information 116 can be downloaded or accessed (e.g., on a web page linked to the user's account with the server 106), or even a person (e.g., at a call center) that contacts the user 102 to provide the related information 116 in a phone call at a more convenient time. In some examples, the server 106 can also function as the information provider 114. Sending the related information 116 to the information provider 114 instead of the device 108 may be more convenient for the user 102.

Any of the interactions with the user associated with the received code can be recorded. For example, recording an interaction can include storing tracking data associated with the interaction. The tracking data can processed in various ways including filtering, and can be used for various purposes including reporting or analyzing patterns of interactions between the system and various users, as described in more detail below.

The system 100 enables a user with a communications device to actively retrieve and/or passively receive pre-selected content from multiple resources. In some implementations, the communications device has hardware and software to provide various functions such as a user interface that can recognize voice input and/or DTMF input, communications circuitry for reception and transmission, and conversion modules to convert content from any form of media. The converted content can be created by retrieving a digital copy of a digital record associated with it, and processing the digital copy for a web-based personalized application. The code that is used to request additional information (such as associated digital content) can include any of a telephone number, server program address, and a set of and/or range of characters. The transmission is communicated to at least one server that recognizes the code, the originating telephone number associated with the communications device, the device identifier associated with the communications device, and combinations thereof. The system can accommodate additional identifiers such as GPS coordinates, time/date indices, and other parameters described herein. The server retrieves the digital content and processes content and outputs based on user input (such as one or more commands received with the code for processing the content), a user and/or program profile, and combinations thereof.

### EXAMPLES

Various examples of system implementations and usage scenarios are described below.

In one example, a radio media application may contain an advertisement that may be accompanied with a content code which may be in a variety of forms, such as a telephone number associated with a radio station or a radio program and a character string associated with the advertisement which may be, for example, transmitted via a RDS transmission and displayed on a motor vehicle console, as well as promoted by a radio announcer. The content code may also be in the form of a character string for an ad slogan or a company brand, in part or in whole. For example, an illustrative procedure for engaging a media audience while providing a convenient way for a media user to partake in a program promotion (such as, for entering a contest associated with a soft drink brand) may be sending the following text, “DEW” to a short code domain. The text string may be transmitted to a server port and processed by a program running on the server. Upon the receipt of the transmission, the program may capture the identifiers associated with the device and/or name associated with the sending user's text address. The program may utilize the identifiers as content codes for the use of a user profile table lookup or the generation of a new user profile associated with the identifiers. Upon the match of a profile lookup or creation of a new user profile, the program may tag either of the profiles with a unique identifier and utilize the identifier as a contest entry confirmation, and message the user with a contest entry acknowledgement. The acknowledgement may include an instruction to go to a web site (e.g., tagnow.net) to access the user's contest entry identifier, post, tag and store the entry identifier on the system site and engage other content and media that is of interest to the user on the site. There are a variety of other content codes and other embodiments that provide the means to conveniently facilitate the preceding transaction, other similar transactions, as well as a variety of other transactions.

The system content codes facilitate interaction with and personalization of any content from any form of media and other sources. The media can include any of a variety of advertising, marketing services, media (including, for example, broadcast, cable, satellite, IP, and/or broadband television and/or radio media, print, movie, music, event, show, concert, and celebrity media, as well as a variety of recorded media), media services and locations (including, for example, gaming, resort and theme park locations). The utilities associated with the identifiers and their respective applications adds significant value to system users, any media entity, content provider entity, advertising, as well as any entity that requires promoting its product and/or service.

One of the utilities associated with the system is to enable any user of a cell phone or wide area network device to engage any form of media and associated content, including, for example, programming and associated content related to, for example, broadcast, cable, and/or satellite television and radio media, print, movie, music, events, and recorded media.

The system also accounts for various forms of functionality at the device and server level to facilitate media and content access (as well as other forms of information of interest to a user), and its respective use and personalization.

The system does not require enhanced functionality at the device level to accomplish its basic utilities of personalizing media and content. In one embodiment of the system which may utilize a cell phone, the system may comprise the following: a cell phone or other wide area network communications device; a form of media; a content code and/or object coding and record system; and at least one server or gateway interface with the associated communications, software, and memory to support interaction with the cell phone or other wide area network communications device and digital content or links associated with the content code and media system. In addition the system may comprise at least one server to comprise the digital content associated with the media and a communications interface, software and memory to support interaction with the server or gateway interface.

A purpose for the preceding components is to facilitate the use and/or management of content when the user desires in a means that compels the user to engage such action. To be more descriptive of the utilities of the system, the following narrative will account for the utilities which may be delivered from the illustrative embodiments, for example the embodiments, accounted for in print, radio and television media adapted for the system.

Print Media:

The system may support and comprise any form of print media, such as for example, newspaper, magazine, billboard, poster, digital signage, marketing collateral, and even plaques or signs that may be associated with a variety of subject matter, from museum piece plaques residing in a museum to plaques or signs related to historical homes or buildings to zoo exhibits.

The system comprises a content and/or object coding system. The system may be architected under, for example, a library records system, an information technology data archive and records system (including tagging systems), and/or combinations thereof. Each content and/or object classification code may be associated with other content or object classifications. For example, an advertising campaign that may comprise a number of advertisements in a variety of print media (newspapers, magazines, etc.) may comprise a series of codes that are associated with the user or reader, the media provider, the media publication, the media issue, as well as the section, region, page number and column, etc. that the campaigns ads may appear. In addition, each content and/or object classification may be associated with other content or object classifications such as URLs and other advertising categories. This latter point will be explained in further detail herein.

An example of a user's use, out of a variety of uses, for the content and associated coding may occur when one is scanning a newspaper. The user, utilizing a cell phone or other device with an input interface and a wide area network communications capability or communications interface that may interface with a device that supports a wide area network communications capability, may perform, for example, the following procedures and steps to review content of interest to the user at a more convenient time or engage the content in a convenient on-demand manner or engage a live person (e.g., a call center agent).

If the user is interested in reviewing the content and/or ads at a more convenient time, the user, utilizing a basic cell phone, may input a telephone number or text number/name/code/character string associated with the media publication (the number or character string may be saved as an abbreviated dial number, such as “WSJ” for the Wall Street Journal or “USA” for USA Today). Alternate user interface elements to facilitate input vary depending on the type of communications channel (e.g., telephony, text or browser-based) that is used by the user and are noted further in the narrative. For the purpose of illustration, the initial input sequence associated with this embodiment's operation description may be associated with a telephone number. The telephone number may be associated with an interactive voice or automated response system or a server interface that accepts number and character string streams. For example, upon the input of the number, the user may insert a pause character, such as a “,”, to input a series of character, code strings and/or code/character ranges. The code, character strings and/or ranges represent the codes associated with articles, ads and/or other media, products, services and/or commands related to the print articles, content and/or ads that the user may be interested in, for example, reviewing, storing, commenting on, tagging, blogging and/or sending to other associates who may also be interested in the content.

In accounting for the respective content of interest, the user may perform the following: input one code and/or code range or string which may be for the entire publication, or section(s); or input a series of codes which may be for the preceding or highlighted articles and/or ads.

The user, upon inputting the codes of interest, may hit the “Send” or “Call” key or character/function key that enables the transmission of the input information to a server or gateway port associated with the dialed or text-transmitted number or address (depending on the user's communications device).

Upon the receipt of the transmission, the respective system gateway port and server may generate a program that captures at least the originating number or device identifier associated with the transmitting device and time and date stamp the receipt of the communication. The program may also initiate a match lookup of the originating number/ANI or device identifier from a user profile database (although it is not necessary for a user to have a profile or be registered to utilize the system). As previously noted herein, the server program may also accommodate users who desire to block the use of the ANI associated with their respective communications device.

If there is a match, the user profile may be retrieved and processed to generate another program or sub-program regarding the instruction set for handling user preferences associated with the content. For example, the user profile instruction may be to retrieve the designated digital media version of the print media content and associated advertising and collateral (designated herein as the “associated digital content”) from (a) designated server(s) and/or storage medium and process and store the content in a designated and catalogued manner for the retrieval, review, management and/or processing by the user. The associated digital content may be stored, retrieved, managed and processed through a number of techniques. One such technique, for example, is a personalized web site adapted for the system. It is to be appreciated that other forms of web sites and web media, which may be but are not necessarily personalized, can be adapted for the system. Examples of some of these forms are described herein.

The personalized web site may be accessible to the user as a URL that is supported by the gateway server. The personalized web site may comprise tagged content from any media or other source such as, for example, the content and media described herein via the system and its device components, as well as user generated and/or submitted and categorized or tagged content. The content or associated content headers and identifiers may be optioned to be shared, private, and/or a combination thereof. The personalized web site may include content and media user profile settings, user profile settings, media profile settings, and/or media entity profile settings, wherein the settings may vary by, for example, content, media, frequency of use, brand placement and use, hierarchical thresholds, and other presentation and storage characteristics. The web site may also offer a variety of user services, such as, for example, online auction services, techniques for facilitating the auction services (which include services uniquely adapted for the system), a variety of search services, which include, for example, search services uniquely adapted for the system, classifieds services, micro-payment services (which include, for example, payment services uniquely adapted for the system, such as a charity donation service associated with each user's activation of a tagged call or communication to (a) designated content code telephone or text number/address), download services (which include, for example, download services adapted to the system), games, (which include, for example, gaming adapted to the system) and content storage/classification, and email/messaging (including, for example, integrated voice messaging or commentary) services associated with the content and/or separate from the content. The display, storage and processing of content may be supported via a variety of advertising, a subscription service, sales transactions, sales commissions, content tagging transactions, content conversion transactions and/or (a) combinations thereof.

The personalized web site may also be a locker, a widget, or hyperlink as part of an existing web site, not residing on the gateway server, or a series of lockers or widgets associated with one or a series of web sites or services associated with a user. For example, the site may comprise the same functions, media, support and service offerings as described in the preceding paragraph. An example of a content tagging application associated with media such as publishing that may be integrated with a personalized portion of an existing web site is a catalog, magazine, or circular discount tagging service. This type of tagging service is designed to facilitate purchases sourced from printed media. It is to be appreciated that inclusive or other embodiments may also comprise web-sourced media. This service is targeted to convert more readers into buyers buy adding more utility than what is currently offered in a web-based shopping cart function. In this application, which may have many sub-services such as, for example, database search and item suggestion services, a catalog reader may be incentivized to tag catalog items that they consider purchasing over a certain period of time. By tagging a certain amount of items that they consider purchasing by a certain time period, the prospective buyer may receive a discount or coupon associated with their next purchase. As noted herein, this service may integrate with other like services, such as notifying the prospective reader, through a variety of means, when one of the tagged items is running near a low-stock inventory position. This function also brings utility to the respective retailer wherein, in addition to providing additional means for generating sales, the retailer may measure items of interest and plan accordingly. It is to be appreciated that this application may also be solely web-based wherein a tag and/or shopping cart function may be integrated with this incentive service.

The user profile may also account for performing functions associated with certain data, for example, recipes associated with a media form or program (i.e., print, television, radio, etc.) may go to designated storage, as well as device(s) and/or communications services such as, for example, an email, podcast, videocast or system personalized content display as noted herein and illustrated as part of the system.

The user may utilize the content codes without the requirement for pre-registration. For example, if the user is interested in a print ad or article in a newspaper, such as the Wall Street Journal, for example a real estate advertisement, the user may input the number associated with the server or gateway port that supports the system service for the publication, input a pause character and input the content code number or character set associated with the respective real estate ad, and upon depressing the respective call or send button, the user need only listen to a voice response or receive a text response (depending on the system embodiment and the user's desired options) acknowledging that the personalized content transaction was completed. The user may then be prompted to register via a voice, cell phone keypad or smart phone keypad input sequence or not opt to register and receive instruction or a callback at a designated time or interval wherein the instruction is associated with the user going to the gateway server or the respective media company's server adapted for the system or another web server adapted for the system and input the user's reach number or address associated with the device that the user utilized for the personalized content conversion or input another means that the user opted to use via the initial transaction or callback sequence. Upon accessing the respective server, the user may input his/her respective device identifier or telephone number and access the desired content for the purpose of utilizing the content for a variety of functions, including, for example, tagging, parking, retrieving and/or storing the content/collateral/pictures/specs associated with the real estate advertisement. Alternatively, in some system configurations the user may be required to register before accessing the content. The user may have other options and require other input means before retrieving the user's designated personalized content.

In other system embodiments, the system may automatically generate the related information 116 associated with a user inquiry (i.e., submission of a content code), where the user may chose to retrieve the related information 116 as an immediate output of the inquiry session on a device from which the code was sent or at a more convenient time the same or a different device. For example, the related information 116 may include real estate property information where the input of the content code such as a property code for a house listing may be performed via a text message (for example, 2XXX to a short code domain) or a telephonic Interactive Voice Response (IVR) session (877-TAG-4 ERA, code # 2XXX). In the IVR session example, the user may opt to receive a text message description of the property which may include a link to the stored related information 116 for the property, called a “media tag”, that may include: 1) a picture of the house, a link for accessing more pictures, the price of the house, and other house information; 2) agent contact information; 3) agent services, such as one-click email requests, for example, call me, request a showing, ask agent a question, etc.; and 4) targeted advertising, such as the agent's recommended mortgage company or legal service.

The respective real estate media tag and associated information can be retrieved from the device as noted in the above explanation, the user may also go to a web destination (which may be one of many designated web sites, or portions or extensions of web sites) and retrieve the media tag by accessing a web locker that includes his/her tagged information. This may be done in numerous ways. For example, a non-registered user may go to www.tagnow.net and input the telephone number of the mobile phone that they used to send the content code to tag the information or input a unique identifier generated from the respective inquiry session that they received along with the respective property information. Upon inputting the telephone number or identifier and hitting a “Get My Tags” button, the media tag and its associated content is presented to the user. In some implementations of the system, the user may save the media tag under whatever keyword(s) he\she desires, for example, “real estate, best house, smith st, beach house,” etc.

Additional System Functionality:

In addition, the user, depending on the type of communications device being used, may input the content codes associated with the media publication and/or content and input a command to have the respective content display on the user's device and/or other devices. The utility associated with this transaction saves the user time, because the user is not required to input or go to a designated URL and then go to a particular section associated with the URL. An additional benefit to the user and other system participants is that the content, article, advertising or collateral, may be supported with additional advertising or information that may be more pertinent for the user, because the processing and delivery of the additional content may comprise a user profile match based on the user's initial connection to the respective server port. It is to be appreciated that there are many embodiments and applications associated with the system that are useful for a variety of users, including mobile device users.

The capability or preference for having desired print media content and/or other related content appear on a user's device (or user designated devices) as described in the preceding paragraph may also be accomplished automatically via a user profile. For example, a user may be reading an article or report associated with a football game. To review the game or game highlights or even a referenced highlight on the user's portable device, wherein the highlights may be in a variety of forms, such as for example, video, audio or text, the user may input the respective content code(s) associated with the content and transmit the identifiers to the system server associated with the content. In addition, the system server's user profile or the user's cell phone adapted for the system may comprise a profile with a preference setting that automatically stores video sports content or links to the designated content on the user's system personalized web site or cell phone for immediate (depending on the functionality of the user's cell phone) or later review. This capability, like many other device and software enhancement levels, minimizes additional input or command sequences for the user to perform.

Additional functions and/or profile preferences may be to receive event or event related promotions, music, and/or video downloads to a user's device, such as, for example electronic coupons and performing a transaction associated with the promotion. A sample application may be associated with a race program guide advertisement, wherein upon the day of the race, the user may read an ad to receive an electronic coupon or initiate a transaction at a special discount within a certain time-bounded period by inputting the media provider or sponsor (i.e. NASCAR) number or speed dialing or texting, etc. the number or address with the respective content code(s) associated with the promotion. The system may also enable the purchase of a respective product or coupon via a user profile account or other account means that is registered and set up to support the transaction (through a variety of means, for example, credit, debit, monthly limits, limit or threshold notification and authorizations etc.). The security of the device identifier coupled with other security means and advertising and/or transaction codes and content codes may easily accommodate the transaction.

In addition to a variety of purchase transactions, the system supports a variety of other interactions, including combination purchase and interaction transactions. One example of the combination is the donation of a micropayment or small or other amount of money upon a user's use of the system. For example, a listener of a radio show who is interested in donating to a certain charity and also interested in tagging certain program content such as an interview transcript or more information about a particular book, may utilize a user profile feature that may utilize the user's debit or credit card account (among other means for performing (a) transaction adapted to the system) for every type or a certain type of personalized content conversion the user may perform up to a certain threshold or other parameter. For example, the user-donated personalized content conversion may be associated with the user speed dialing the number associated with the system server port that is associated with the program and the user acknowledging, but not necessarily, a confirmation of the donation. Such use of the system could facilitate and provide for additional finds to charities without burdening each respective donator.

There are a variety of related and other features and functions associated with the system to facilitate simplicity, ease of use and convenience for the respective user at the web server and user device level, especially for the portable device user. Depending on the capabilities of the user devices adapted for the system, the user may send content as well as commentary to other users' devices via web server interaction and/or desktop search interaction, messaging or email interaction via the retrieval of designated recipients and the tagging and parking of digital content to the message(s) recipients. The system may support a variety of users associated with the preceding statement, for example, a user may convert an item of interest and choose to verbally comment about the item wherein said verbal commentary may be initiated through an interaction with the server program or initiated as a voice messaging application through the user's cell phone or cell phone carrier service (or through an audio and/or video dictating apparatus integrated or separate from the cell phone that may have an upload capability to the server). The voice and/or video message may be posted to the server program as personalized content and tag coupled with the user's content of interest.

The preceding verbal and video commentary functions and their respective interactions are illustrative of the variety of utilities supported by the system. For example in a basic form, the system users may submit and categorize their verbal commentary for, at least one of, private and community use to facilitate the organization of memos, reminders, to-do lists, answering machine or voice messages, innovative thoughts, as well as a variety of greetings, as separate content items of interest that may be tagged, stored reviewed and disseminated through a variety of means. As noted in the preceding paragraph, the system may also support said commentary functions with additional content, from digital pictures to a variety of web-based and/or electronic greeting cards adapted for the system (for example, the integration of a code with at least one of an identifier and other parameters described herein provide for utilities that facilitate the creation, personalization and dissemination of unique greeting embodiments which may be in the form of virtual, electronic, audio, video, digital, print media, mechanical, other object form, and/or combinations thereof), RFID transmitted (or other code and transmit means) item identifiers from a storefront display or a store shelf that a user may choose to convert, tag and comment on as a more convenient and helpful window shopping-“Add to Cart” function, to other uses that an engaged user community will create through the use of the system.

In addition, depending on the device and/or device interface capabilities, the content code(s) may be input to the device via OCR, bar code, RFID, audible, verbal and/or other scanned and/or transmitted means. For example, the device can use telephony, voice over internet protocol (VOIP), voice SMS, or voice XML. In addition, the system can use techniques such as RFID tags, printable RFID, bar code, and electronic paper text and graphics that may be linked to (a) communications transmitter(s) to facilitate user input, wherein, for example, the RFID-equipped user device, upon receiving a RFID chip transmission, identifying the media provider content code or number, may generate a look up program to retrieve the device call function, such that the user may scan and edit the articles/ads of interest and depress the call button, wherein the user may not need to perform any input function other than depressing the device call button. In some implementations, call initiation is automatic (without requiring the user to depress a call button). In other system embodiments, the transmission is not triggered by a user.

Audio and Radio Media:

The system may support any form of radio broadcast and program, such as for example, satellite radio, digital radio, AM and FM radio, RDS transmission, HD transmission, streaming, as well as regional and national programming. In addition, the system supports a variety of program content and related subject matter (such as, for example, advertising, books, services, music, audio book and video downloads, etc.) formats, for example, from talk radio to music to combinations thereof, and transactions (some of which was described in the previous section herein).

The system may also comprise a content and/or object coding system. The system may be architected under, for example, a library records system, an information technology data archive and records system (including tagging systems), and/or combinations thereof. Each content and/or object classification code may be associated with other content or object classifications.

For example, an advertising campaign that may account for a number of advertisements in a variety of media outlets (radio, newspapers, magazines, etc.) may comprise a series of system content code codes that are associated with, for example, the following: the user, reader, listener, viewer, the media provider, the station, the advertiser, the advertisement (there may be a number of codes associated with the advertisement), the sponsor, the sponsor's product and/or service, and the broadcast time slot. In addition, each content and/or object classification may be associated with other content or object classifications such as URLs and other advertising categories.

An example of a user's use, out of a variety of uses, for the content and associated the content code coding may occur when one is listening to the radio while commuting. The user, utilizing a cell phone or other device with an input means and a wide area network communications capability or communications means that may interface with a device that supports a wide area network communications capability, may perform the following procedures and steps to review content of interest to the user at a more convenient time or engage the content in a more convenient and safe (for example, when the user may be driving a motor vehicle) on-demand manner.

If the user is interested in reviewing the content and/or ads at a more convenient time, requesting product or service information, or performing a transaction or other interaction associated with the radio program content, the user, utilizing a basic cell phone, may input a telephone number or text/short code number associated with the radio station/channel (the number may be saved as an abbreviated dial number, such as, for example, “WEEI”, “WFAN” or “WABC”). Upon the input of the number, the user may insert a pause character, such as a.“,” or “*”, to input a code or series of character or code strings and/or code/character ranges associated with the content of interest. The code or character strings and/or ranges may represent a variety of content such as, for example, the content codes associated with a commercial or a book or system commands that, for example, facilitate the purchase of the book that may be marketed through the respective radio program.

As an alternative, to facilitate convenience, simplicity and safety, the user, upon responding to the respective content of interest, may speed dial, text or enunciate the number, address or name associated with the broadcast station delivering the content, such as enunciating, for example, “WABC”. In an embodiment that comprises an interactive voice response integration, the user may verbally input a command and a code, such as, for example, “Call Geico” to process the code “Geico” according to the command “Call” to connect directly to a Geico call center agent, or the user may say, “Tag Geico” process the code Geico according to the command “Tag” to receive a text message associated with the respective advertisement, In addition, the tag command may also activate the posting of a media tag content to be accessible in a portion (e.g., a page or frame) of a web browser that comprises, at least, information associated with the respective advertisement, wherein the respective frame may be accessed via at least one web destination such as, for example, a personalized web locker or temporary web locker.

It is to be appreciated that the system utility of enabling a variety of hands-free activations and responses to broadcast programming provide for convenience as well as, especially for radio programming, supports safety.

It is also to be appreciated that a variety of voice and/or touch-tone prompt activation features may be incorporated in the system. One system embodiment may be designed at a radio station level, wherein an interactive voice recognition system may be configured to recognize a respective user's verbal and/or touch tone input where the input may be applicable to a select choice or database of keyword codes and commands associated with programming and advertising at any given moment of the respective station's program. For example, a listener may call a telephone number associated with a radio station (e.g., 877-770-WABC) and say, “IMUS” or press a number on his/her phone's keypad, such as “2”, to tag the interview he/she is hearing and/or IMUS program highlights of that respective day. The same code, “IMUS” or “2”, may be input another day to tag the associated IMUS content of that respective day. Advertising may also accompany the respective tag either/both as a placement during the IVR session and/or as part of or associated with the media tag as presented in a portion of a web browser. In some embodiments, set codes are associated with interacting with programming and advertising at any given moment of the respective station's program. The codes may be associated with a data stream, such as, for example, a RSS feed associated with a media monitoring service, where the stream content, or a portion thereof, may be an output to a user in response to a user's access to the stream content via a text, browser, or IVR connection. In the context of an IVR session, the user may call into a telephone number, such as for example, 877-770-9222, and choose from a selection prompt to hear or connect to, for example, the current or most recent advertiser, or hear the most recent set of advertisers. The output to the user may be in the form of a text-to-speech synthesis read and the interactive points associated with the respective session may be provided via the programming and integration of the IVR system with the RSS feed or components there of via, for example, Voice XML. In the event that the user inputs a code to hear, for example, the most recent advertiser, the system may provide a prompt for the user to connect to the advertiser's call center or provide a prompt to post content or information associated with the respective advertisement through a variety of outputs, including a SMS (or SMS form such as a WAP-Push), MMS or the system media or web tag. The means to activate a connection associated with the advertiser's call center may be provided in a variety of forms, for example, the output associated with the user's input to connect to a live operator may be the name of the advertiser as an input into the lookup function associated with the respective radio station's advertisers, where, the lookup function provides the output of the activation program to bridge the user's call and dial the respective number associated with the advertiser of interest. The logic associated with the output of a posting, which may be in a variety of forms, may essentially follow a similar sequence where the advertiser name may be the input into a database lookup function that provides an output activation associated with the user's selection. For example, upon the activation of a request for information in the form of a media tag, the system may perform a function that captures the communications device identifier associated with the user, such as, for example the telephone number associated with the device, retrieve the information record associated with the advertiser name from the database and activate the associated program that posts the associated media tag at the designated web site location(s) upon the input of the respective device identifier or an input association with the respective device identifier, such as, for example a cookie or code that is unique to that respective identifier.

It is to be appreciated that the RSS stream and associated interactive session described in the preceding embodiment may apply to other system embodiments, such as for example television programming and advertising. In addition, as previously noted herein, the RSS stream and the associated interactive session may be a standalone interactive media channel, for example, a sports information line, which is described further herein.

In another system embodiment, the user may not need to input the number associated with the broadcaster, for example, the broadcaster number or content code for the broadcast may be transmitted as part of the broadcast frequency band signal, such as, for example a RDS, satellite or HD radio transmission. Upon the user's activation of a radio adapted for the system embodiment, the radio, equipped with a wireless communications technology protocol such as, for example, Bluetooth or ZigBee, may transmit the broadcast telephone number and/or the identifier code associated with the respective gateway or server identifier for the station. Upon the receipt of the communication by the user's device, such as for example, a cell phone equipped with the associated communications means to support the receipt, the receipt may activate a program that generates the call program for the device. The call program function may differ depending on the content received from the radio, for example the received code may be a telephone number that is associated with a communications channel that terminates into the server platform of the system and bridges with a communications channel that terminates into an advertiser's call center (wherein as previously noted, the telephone number may be utilized by the system as a content code embodiment).

In the instance that a listener may chose to tag on-air content or information associated with on-air content, the listener may opt to have his/her cell phone receive the telephone number associated with personalizing and/or converting the broadcast content. Upon the receipt of the telephone number, the telephone number may be automatically dialed upon the user's depression of the call or send button or voice command associated with the activation. In the instance of receiving the personalization/conversion code associated with the respective station program content, the cell phone device program may retrieve the general number for the gateway or server and append the number with a pause character followed by the respective station code. In the latter example, the function supports the capability of calling one number and stringing the pertinent code(s) associated with the user's interest/transaction. In either application, both transactions are captured. There are a variety of other techniques and other components of the system for accessing and converting information of interest to personalized content.

In another system embodiment, the radio program content code(s) may be transmitted via an RDS, satellite or HD radio broadcast and displayed on the motor vehicles radio or console system, from the respective telephone number to the respective codes. The code(s) could be displayed, manipulated, and/or managed via an input associated with the radio or console. The user, upon viewing the identifier information, may input, (e.g., using speed dial or voice command) the respective codes or names to initiate the personalized content conversion. In addition, depending on the type of motor vehicle console and car communications system adapted for the system (including, for example, the information and device controller system), the user may voice command the instruction associated with the management of the identifier codes in the car system as well as with the server system. For example, the content code or code string may be or comprise a GPS coordinate associated with a restaurant location or the location of an event, wherein the code may be input into the vehicles GPS system as a mash-up input to the system. In addition, as exemplified in the use of networked device code transmissions, the GPS coordinates may be received by the cell phone of the user. The driver may choose to utilize the integrated GPS information in a number of ways. For example, he/she may choose to utilize the guidance information, immediately, or at a more convenient time (e.g., by saving it at both the device(s) level as well as his/her personalized web via an automatic posting at his/her web locker. The driver may choose to save the code and/or string for retrieval and input into either or both the car and/or cell phone/network GPS system as well as a tag or map system on the user's personal web site.

While the user may be driving, upon activating a parking command to the web server wherein the command is associated with storing the event and event related content codes at the user's respective personalized web site or web site locker, the user may also voice command or input a search command for restaurants based on the user's preference profile that are in proximity to the event. The search results may be voiced back to the user and/or transmitted to a user-designated device via a user command or user profile setting. It is to be appreciated that the system may support a variety of functions to facilitate user convenience.

With respect to accessing the variety of servers, the system accounts for other means for accessing the appropriate port and/or operator (real or virtual) associated with the user's desired transaction(s) whether the user has a number or content code(s) associated with the broadcast media program.

Upon the call activation to the designated port and/or agent, a user, who for example, has taken action associated with an ad and/or program content, may either reach a live operator associated with the respective ad or automatically tag and park the content (content includes, but is not limited to including, video—i.e. podcasts, audio—i.e. podcasts, merchandise, advertising, transcripts, articles) associated with the respective broadcast via the gateway or server, at minimum, the content can be, again, parked at the user's personal web space and/or web site (there are a number of choices for easy minimum-step registration), or depending on the cell phone/portable device, the associated program or program-related content can be parked on the user's portable device for live interaction or post for later use, or the content may be automatically managed and/or disseminated per the user's profile in the system server or gateway without the need for user interaction.

As previously noted herein, the system also accounts for means to facilitate the personalization and engagement of the radio program content through other software and device enhancements, including radio device and cell phone or other user device enhancements adapted for the system.

Video and Television Media:

The system may support any form of television broadcast and program, such as for example, satellite, cable, broadcast spectrum, IPTV, and broadband, as well as community, regional and national programming. In addition the system supports a variety of program content and related subject matter (such as, for example, advertising, television shopping, talk show collateral and related products, services, music, video, movies as well as audio and video downloads, etc.) and associated formats.

The system may also comprise a content and/or object coding system. The system may be architected under, for example, a library records system, an information technology data archive and records system (including tagging systems), and/or combinations thereof. Each content and/or object classification code may be associated with other content or object classifications. For example, an advertising campaign that may comprise a number of advertisements in a variety of media outlets (radio, newspapers, magazines, etc.) may comprise a series of codes that are associated with, for example the following: the user, reader, listener, viewer, the media provider, the station, the advertiser, the advertisement (there may be a number of codes associated with the advertisement), the sponsor, the sponsor's product and/or service, and the broadcast time slot. In addition, each content and/or object classification may be associated with other content or object classifications such as URLs and other advertising categories.

An example of a user's use, out of a variety of uses, for the content and associated coding may occur when one is viewing a cooking show program. The user, utilizing a cell phone or other device with an input means and a wide area network communications capability or communications means that may interface with a device that supports a wide area network communications capability, may perform the following procedures and steps to review content of interest to the user at a more convenient time and/or instantaneously.

If the user is interested in reviewing the content and/or advertisements at a more convenient time, requesting product or service information, or performing a transaction or other interaction associated with the program content, the user, utilizing a basic cell phone, may input a telephone number or text number associated with the television station, channel and/or network (the number may be saved as an abbreviated dial number, such as “FoodNet”, “ESPN” or “MTV”). Upon the input of the number, the user may insert a pause character, such as a “,”, to input a content code or series of character or code strings or ranges associated with the content of interest. The code or character strings or ranges may represent a variety of content such as, for example, the code associated with a commercial, book or a recipe that may be featured through the respective television program, as well as, as previously noted herein, a company or company product brand or ad slogan.

Alternatively, for the support of convenience and simplicity, the user, upon responding to content of interest, may speed dial, text or enunciate the number, address or name associated with the channel delivering the content, such as enunciating, for example, “FoodNet”. The user's response may be associated with tagging a certain highlight, recipe or advertisement associated with the program. The response may be prompted by an icon, marker, or text/graphic/video roll/insert displayed on the user's television screen, an audible prompt heard through the user's television speaker, or through a combination thereof that indicates that the particular content may be tagged.

In some system embodiments, the user may not need to input the number associated with the broadcaster, for example, the broadcaster number or content code for the broadcast, or for the advertiser, may be transmitted as part of (e.g., embedded within) the broadcast frequency band signal. The presence of the embedded code can be indicated by a prompt (e.g., audible or visual). Such a prompt can also be associated with a function (e.g., call, tag, buy, post, and send) available upon submission of the appropriate command.

There are a number of techniques and system embodiments for extracting the code from the broadcast content. For example, a television or set-top box may extract the code associated with a call to a call center upon the activation by a user through a television remote associated with the respective television or set-top box. The television or set-top box may be adapted or configured to network with and activate a variety of communications devices associated with making the call to the respective call center (for example, a cell phone or wired phone with either a PSTN or VOIP connection that provides a way to network with the television or set-top box).

The extraction of the code from content can also include the communication of an instruction set that activates a device with a network connection (e.g., a telephone including a speakerphone). The activation of the device with a network connection can include the generation of a telephone call associated with the code, and can activate a speakerphone. The extracting can be initiated by the user, for example, using a remote control key or button, a speaker, a motion sensor, an optical recognition, or a touch screen.

Upon the user's activation of a television or set top box adapted for the system embodiment, the television/box, equipped with a wired connection, such as a USB cable, or wireless communications technology protocol such as, for example, ZigBee or Bluetooth, may transmit the broadcast telephone number or code associated with the respective gateway or server identifier for the station. Upon the receipt of the communication by the user's device, such as for example, a cell phone equipped with the associated communications components to support the receipt, the receipt may activate a program that generates the call program for the device. The call program function may differ depending on the content received from the television/box, for example a content code versus a telephone number.

The communications channel between the user's device and the system can be based on the embedded code, and optionally a command from the device. For example, in the instance of receiving the telephone number associated with personalizing and/or converting the broadcast content, the telephone number may be automatically dialed upon the user's depression of the call or send button or upon the user's voice command (depending on the capability of the calling device). In the instance of receiving the personalization/conversion content code associated with the respective station program content, the cell phone device program may retrieve the general number for the gateway or server and append the number with a pause character followed by the system respective station identifier code. In the latter example, the function supports the capability of calling one number and stringing the pertinent content code(s) associated with the user's interest/transaction. In either application, both transactions are captured.

The system accounts for other means for accessing the appropriate port and/or operator (real or virtual) associated with the user's desired transaction(s) whether the user has a number or the identifier code associated with the broadcast media program. The system also accounts for other means to transmit the program station code or telephone or text number associated with the system server port supporting the television channel or program content to the user device/cell phone or remote control unit adapted for the system. One of the means is via any one of the various embodiments of the information and device controller.

Upon the call activation to the designated port and/or agent, a user, who for example, has taken action associated with an advertisement and/or other program content, may either reach a live operator associated with the respective ad or automatically tag and park the content associated with the respective broadcast via the gateway or server. At minimum, the content can be parked at the user's personal or designated web space and/or web site (even though some system embodiments do not require registration or initial registration, there are a number of choices for easy and convenient minimum-step registration), or depending on the cell phone/portable device, the associated program or program-related content can be parked on the user's portable device for live interaction or post for later use, or the content may be automatically managed and/or disseminated per the user's profile without the need for user interaction, such as a posting to his/her personal web site and/or associated device(s) such as a personalized content display that may be in a user's kitchen. As previously noted, based on the user's profile, the display may also automatically receive and display a desired recipe associated with the cooking program as a result of the user utilizing a variety of devices and means for input such as, for example, depressing the send or call button associated with the abbreviated/speed dial menu name, “FoodNet”, on his/her cell phone, clicking or touching a button on his/her remote, moving his/her hand in front of an optical sensor/camera, and/or utilizing an input device with an accelerometer sensor.

As previously stated herein, the system also accounts for means to facilitate the personalization and engagement of the television program content through software and device enhancements, including television, set-top box, streaming media player and cell phone enhancements, such as, for example, a cell phone equipped with a UHF chip set for receiving television programming broadcasts, or other user device enhancements adapted for the system. The enhancements will be accounted for further in the narrative. In addition, the system accounts for broadcast content adapted with the user device(s) and/or any form of communications device and, as appropriate, profile, permission and authentication methods associated with the user, to facilitate greater interaction and engagement including, for example, instant polling, purchasing, voting, gaming, and sharing to enhance and promote (across user communities) the viewing experience.

It is to be appreciated that as cell phone devices, set-top boxes and other associated devices, APIs and systems become more open to developers, the adaptations described herein may be in the form of yet many additional embodiments. For example, a cell phone or mobile computer with telephony, calling and messaging capabilities may comprise a touch screen program that, for example, maps with the functions of a television remote and includes the communications circuitry and compatible functions to interact with a set-top box or set-top box with compatible functions associated with an open architecture program residing on the set-top box or server associated with the set-top box or that comprises a set-top box function that interacts directly with the television.

Another aspect of the system that facilitates user engagement of media programming and brands is the automatic generation of folders that contain content associated with the respective media tags (both offline and online generated tags).

Another aspect of the system that facilitates user engagement with media content and advertising and the understanding thereof comprises measurement, measurement data output and, in some cases, analysis. This aspect is in a variety of embodiments, for example, input and identifier data and subsequent activity (offline and online) may be filtered and output into a variety of marketing systems.

Temporal, Location, Situational and Search Parameters:

As previously described herein, the system content codes also may support the personalization of content based on parameters, such as, for example, temporal, location, situational and search criteria or factors. The parameters can be sent along with the content codes and processed in combination with the content codes to generate associated content.

Embodiments that may comprise temporal parameters may range from a default time and date stamp parameter, such as utilizing the time and date stamp of the receipt of a call initiated from a cell phone and recorded on the respective server program associated with capturing the stamp recording and the respective server port associated with the program to utilize as an identifier of a current running program (absent any other input), to special character content codes as an input parameter associated with capturing content associated with a block of time or an immediate instant, such as, for example, capturing content associated with the last ten minutes of a program or capturing and downloading a current-playing song over a radio program.

Embodiments that may comprise location parameters may range from inputting GPS coordinates as part of a personalized content conversion to utilizing GPS outputs from a personalized content profile as inputs to a user, device and/or system invoked application. As noted in a previous example herein, a GPS coordinate parameter set associated with the location of an event may be utilized in a search application to find certain types of restaurants in proximity to the event.

A system-invoked content code application may complement the preceding search application wherein the search may comprise at least a two-step process wherein the results of the search (wherein the search may account for a variety of criteria such as prior offline and online interactions by the user), may be output to a personalized profile program that compares the search results against a list of preferences by the user, wherein the preferences may account for a variety of criteria and potential additional search requests, before the results are output. For example, an initial restaurant proximal location search may deliver results for a variety of restaurants, the result output may serve as input to the user profile program wherein the program may indicate a preference for Chinese food and/or a certain type of Chinese food wherein the program output may serve as input to a more refined search. It is to be appreciated that the search and user profile program(s) may account for a variety of criteria, such as, for example, hierarchical preferences, food preferences and menu searches, etc.

The system-invoked content code functions may support a variety of other embodiments, such as, for example, a telematics system's information and device controller. For example, the controller's or web server's receipt of a traffic backup alert, wherein the alert may comprise a content code such as an estimated backup duration period, may trigger a system program for capturing the motor vehicle's GPS coordinates and searching for user preferences associated with a stopover in proximity to the GPS coordinates.

Embodiments that may comprise situational parameters may include, for example, social networking applications, game parameters (some of which have been noted herein), online auction updates, refined targeted advertising, and military, civilian, health services, commercial, and homeland security applications. An embodiment example of utilizing the system parameters in a social setting may apply to a user at a night club or interested in going to the club performing a query or a posting associated with meeting a compatible person. This can be accomplished via a text message such as, for example, “Date Joe's”, “Find Joe's” or “Joe's”. In this example, the club may post or advertise a domain or code parameter (e.g., “Joe's”) wherein the domain parameter may comprise sub identifiers, such as for example, GPS coordinates, address, website URL(s), bands or entertainers, music, seating, promotions, a menu, etc. The user may have a profile setting that characterizes the user's social profile and interests that may include a domain parameter, content code, string, range, and/or identifier. In this illustrative application, a user's identifier, such as his/her cell phone number (which is transmitted upon the sending of the short code message), is utilized in context with the respective message/application. If the user is contemplating going to the club, the user may choose to utilize existing profile settings, post or provide select access to his/her entire social profile or parts of his/her profile and post or text the respective codes wherein one of the codes may be a text message address (the address may be for the user or a screening or social networking service for the user) and the user may also post or text the club's domain parameter/code and/or sub identifiers such as its address and/or GPS coordinates (with respect to this example, the user's text transmission of the domain parameter or code is sufficient). Upon performing the posting or texting, wherein the posting may take place at the server, the server may perform a variety of functions, such as, for example, automatically (depending on the user's profile preferences with the server) perform a search for like user profiles at the club or at like clubs via content codes or code ranges. Upon finding a match, the server program may inform the user(s), and the server program may perform a variety of other functions, such as, for example, interact with the users to opt in, support the downloading of user-permitted pictures and profile settings as well as query permissions for device addressing or numbers and user-to-user text messaging. The content code system has a variety of other embodiments to support social networking applications which will be addressed in subsequent patent application filings.\

Another embodiment of the system situational parameter may be utilized to support refined advertising. For example, a positive date/match outcome associated with the preceding application may produce a transmission of a congratulatory free drink coupon or code. Alternatively, a non-match may produce an advertising offer for a drink at another club location. In yet another example of contextual advertising integrations provided through the content conversion process, upon a user's personalized content conversion of a television or radio program or a section of a newspaper, with the user's pre-selected permission, the system media and personalized content conversion process may comprise a program match of the user's profile, wherein the profile may contain characteristics and/or statistics that support the placement of a sponsors product in place of the sponsor's product that may have been placed in the program or newspaper section. For example, upon the profile program match, the advertisement placement of a men's deodorant product in place of a women's deodorant or an acne treatment product may deliver more value to the sponsor and media provider. The system has a variety of embodiments for supporting advertising, such as, for example, more complex factors associated with user profiles and relevant brand, product, and service choice, placement and media.

Embodiments that may comprise search parameters may range from, for example, what has been previously disclosed herein to accounting for user search patterns and identifiers when placing advertisements associated with the user's content conversion, which may deliver additional advertising conversion opportunities, or personalized content. An embodiment example of the latter point is a user's personalized content conversion of a real estate listing or advertisement wherein the conversion process accounts for the posting of listings and advertisements on the user's designated or personal web site page and/or real estate listing/advertisement tag frame wherein the selected advertisement postings may be the outcome of a search of the user's prior relevant and recent ad clicks and/or searches to account for the targeted advertising. For example, if the user had performed searches and/or ad clicks associated with mortgages, then the contextual real estate advertisement information postings may include mortgage advertisements.

It is to be appreciated that this unique advertisement tag integration may apply to a web-generated conversion, such as, for example included in the embodiment of a media tag, and/or a communications-generated conversion, such as, for example, in the creation or posting of a phone or text tag.

An example of a web-generated conversion may be the result of a real estate seeker's activation or click of a tag button on a real estate web posting, wherein the activation generates an output of a media tag that may include a picture of the property, a property listing URL (wherein the URL may be a link address associated with a virtual tour of the respective property), a property description, realtor contact information, and contextual advertising associated with the respective user's prior relevant web activity or relevant advertising based on other parameters as describe herein, such as, for example, temporal, geographical, situational system-invoked (for example, advertising content or placements pre-selected by the respective realtor or listing agent, such as an ad for a mortgage broker that the respective agent may work with), and/or combinations thereof.

An example of an advertisement placement during a phone tag conversion may occur wherein, for example, a caller, who is tagging for additional information in response to a television program regarding do-it-yourself tips related to decking, which may be in the form of an article, video and/or combinations thereof, may hear an advertisement for on-sale decking as a result of his/her input of a code to generate the tagging of the respective content of interest.

Another utilization of situational and search parameters is associated with yet another aspect of the system which is delivering targeted information, including in the form of a media tag, to a designated individual (or individuals) or designated sets of individuals via the transmission of a code (or codes) generated from the trigger of a sensor (for example, bio, environmental, accelerometer, etc.), scanned, manual and/or verbal input. This system embodiment may utilize other parameters and be in a variety of implementations and applications, for example, medical and emergency response, military, border patrol, environmental emergency, reconnaissance and even inventory and shipment tracking. The user can be, for example, a civilian, a service professional, a military professional, a business professional, a scientific professional, a government professional, a rescue professional, a combat professional, a medic, a health services professional, a border patrolman, a shipping and/or warehouse professional, a security professional, or a Homeland security professional.

One example of an implementation of a military application is related to the generation of a media tag that contains a soldier's vital information that is automatically disseminated to designated parties upon the explosion of a vehicle to which the respective soldier is assigned.

The generation of the respective media tag is a result of the activation of an accelerometer sensor that is connected to a stored program associated with a transmitter that sends a code to a secure server that contains the device identifier of the respective transmitter. Upon the receipt of the device identifier, the server executes a program that performs a database lookup of the code and a search of designated information assigned to the respective code.

The code-assigned information may contain data categories such as personnel assigned to the vehicle patrol at the time of the transmission, health and logistical information associated with the respective personnel, vehicle information, and logistical information (e.g., such as, for example, the location of the transmitter at the time of the transmission and the date and time of the transmission). The program is also able to perform a database search associated with the preceding information to retrieve designated recipient information and additional information. This information set may include, for example, field operations, proximal field unit, and proximal medic unit recipients.

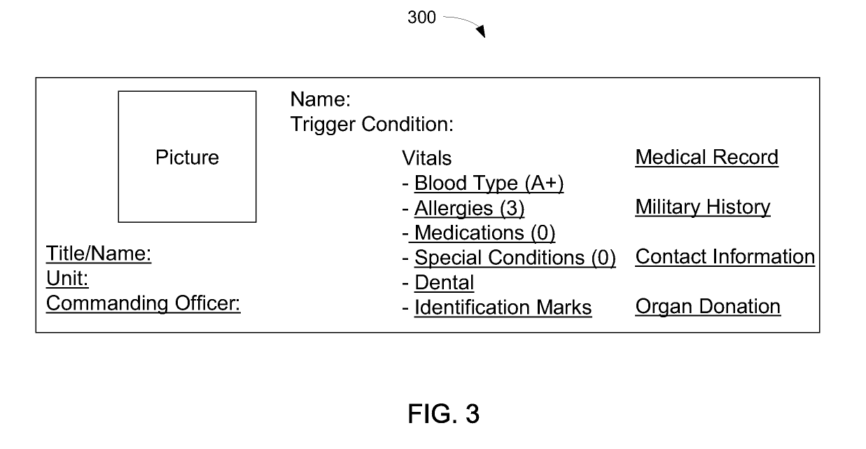

The information may be in the form of graphics, text, audio, video, secure hyperlink, and other secure formats of media. The information may be contained in a media tag and the tag information may vary based on the needs of the designated recipient. For example, a media tag associated with a medic group may include a soldier's vital information (including hyperlinks) as illustrated in FIG. 3, which shows an exemplary personnel identification media tag 300, while a field operations unit may contain logistical field information.

One of the advantages of this system embodiment is the immediate dissemination of information to the appropriate personnel in a way that is readily accessible under one format (the format of the media tag) and highly relevant to each respective recipient's task at hand. Another advantage of providing the information under the system format of a media tag is the indexing and subsequent management and retrieval of the respective media tag and associated information. Sample indexed information fields included in this media tag may include the following: the name of the associated personnel, the name of the trigger condition/transmission (i.e. what caused the output of the tag), the date/time of the transmission, the name of the trigger source (for example, the vehicle, location, user, and/or input device), the designated recipient(s), and other indices and/or keywords of associated information.

In addition to the generation of a media tag, the system may provide other forms of output.

Personalized Content Management and Applications:

The system accounts for a variety of functions and means for managing personalized content. The personalized content management accounts for content conversion, creation, processing, storage, tagging, posting or parking, interaction, adaptation and dissemination. Much of these functions have been accounted for in what has been described herein.

Functions associated with the system include tagging and posting, interactive telephony, and adaptation applications.

The classification means for tagging and posting the personalized content may range from privacy tagging and posting to community tagging and sharing. The privacy tagging and posting may be initiated by the user and/or initiated and facilitated by the system, for example the user may opt to keep the content code associated with the converted content as the tag identity for the content. The personalized content that the user may designate as content to be shared by (a) community(ies) may be tagged and posted to reflect the respective community(ies) participation. Part of the community participation may be, for example, the posting of calendar information (for example for a web-based family calendar), professional contact information (for example, for a web-based professional networking community), relevant advertising, blogging, wiki and text messaging fields, digital pictures and video and audio clips associated with the user's personalized content website or locker or gateway associated with the user's personalized content web site.

In some implementations, the code may be associated with content in a database, and the system 100 can provide content from the database associated with the code to the user. For example, the code can identify a person and the content from the database can include contact information for the identified person. The contact information can be stored in association with an account accessible to the user (e.g., in a social network, a professional network, a contact network, a company network, etc.). The code can identify marketing collateral or advertising, which the system 100 stores in association with at least a portion of a web site that is accessible to the user (e.g., a web site associated with an industry conference or convention or portal, or a business or person). Advertising content can be associated with any of the account or web site examples listed above, and can be based at least in part on a location of the communications device at the time of transmission of the code. An example of a posting and integration for a private use or community share may be the posting of a concert event to be shared for a date. This application may comprise a variety of functions, for example, from booking a specific date and time to requesting a web-based calendar function to search, organize and communicate a match, alert and confirmation of a certain date and time. For example, a radio listener, upon listening to an advertisement for a Diana Krall concert, may dial a designated number associated with the media and/or information provider and enunciate the following, “tag Diana Krall post calendar” or text, “t krall p cal” to a short code associated with this application service. Upon the receipt of the listener-generated communication, a program would perform an identifier match associated with the user's communications device or ANI, and may perform a variety of functions based on a positive match and access to the respective user's profile. Said profile may include a permission feed and transmission to the user's calendar application, wherein upon, the receipt of the code and sub-codes associated with the keyword, “Diana Krall” or “krall”, the calendar application may initiate a program to search for available dates and generate an interactive session with the user and other user-requested individuals (live or in an automated virtual session).

Another example of a communications-based posting for private or community share is the submission of contact information into a web-based personal and/or professional contact system. This function provides the utility of immediate entry, integration and management of contact information through the use of integrating a code into one communication. This application may include various levels of use and integration. For example, a user may be a member of a tagging or social/professional networking service, wherein, he may register the code, “BOBS”, wherein this code provides access to or a posting of designated contact information and, potentially, other user-permissive information. The code, and associated programming and integrated communications means, may provide for the utility of an electronic business card, wherein any individual who is introduced to the code, such as members of an audience, may text, enunciate or input the code via, for example, a telephony, texting or browser device, and receive the contact information associated with “BOBS” through a variety of outputs. For example, one basic output may be the receipt of contact information via a text message. Another output means may be via the receipt of a tag wherein the user may go to a destination and input a code, which may be, but not necessarily, “BOBS”, and retrieve said information. In yet another example, the user may retrieve the contact information via a web-based networking service application, wherein the user may be, or register to be, a member of the respective networking service. In the construct that the user may be a member of the networking service, upon the receipt and match of the identifier associated with the user's communications device, a program may be initiated to search, retrieve and post the respective contact information associated with the code, “BOBS” The posting of the contact information may be at a web-based level, device level and/or combinations thereof with various levels of integration. It is to be appreciated that advertising (including contextual) may be associated and/or integrated in this application embodiment.

In yet another aspect of the system that facilitates quick and convenient access to and management of information, a sales and marketing system embodiment may comprise the automatic downloading, tagging, posting and/or sharing of presentation and associated collateral material to a designated device (or devices) and one or more designated web sites (or portions thereof) via a text such as, for example, “INMAN BOBS”, to a select short code. This embodiment may use various data capture and reporting techniques. This system embodiment may be integrated with and/or be comprised in a variety of marketing and sales collateral, applications and systems.

The system accounts for a variety of telephonic interaction to facilitate personalized content use and management, some of which has been previously noted herein. The telephonic interaction may range from the web server functionality of informing a user of a certain message or amount of messages on an answering apparatus via a network to a personalized content conversion system (with or without user-comment annotations), to ordering take out or a pizza delivery based on converting a radio, television or print media advertisement.

A telephonic application that may support immediate conversion of content by a user and facilitated over a variety of networks, such as, for example, over a traditional PSTN, a wireless switched network, a VOIP packet network, and/or combinations thereof, is an information service. One embodiment of this service is a content conversion information service, which may account for the following: a user dialing a telephone number to obtain, for example, sports information wherein the information may be sourced from a RSS reader, converted as a voice XML feed and output via a synthesized voice stream over an integrated IVR system. In this illustration, a caller, interested in obtaining a baseball sports score or the latest news associated with his/her team of interest may dial a designated telephone number, voice and/or input the name or code associated with his/her team and hear and/or see (depending on the functionality of his/her communications device, which may also support the display of the associated RSS feed) the pertinent team's headlines and/or scores. The caller may perform a variety of functions associated with this interactive system embodiment, for example, scroll (pause, back and forward) through the respective information, or tag, download, forward, comment on or perform other menu functions such as hear and/or see a headlined article (with or without accompanying video) in its entirety, via voice, touch-tone, keypad and/or, depending on device functionality, cursor/click command(s). For example, a respective headline, may be tagged via the input of a “*” key on a touch-tone keypad, wherein the associated article and/or video is posted to a personalized web locker, as well as messaged, downloaded or broadcasted to a mobile phone.

In addition, as stated herein, advertising (including contextual) may be integrated into the content conversion process at a variety of levels. For example, in context with the above illustration, an advertisement for a respective team's baseball jacket that is associated with the input of the team's name may be inserted in the form of an audio clip wherein, the caller may opt, among many options and respective outputs, to be connected to a live agent to place an order. A contextual advertisement or coupon may be downloaded or posted as part of a thank you message to the respective caller for utilizing the information service. In addition, the caller may have a user profile associated with the respective information service wherein said profile may contain a virtual wallet account, along with clothing dimensions, wherein a transaction may be initiated to purchase the jacket via the input of a touch-tone pad character or a voice command. The advertisement may be even more contextual based on the input of additional parameters, which include those stated herein, such as temporal, location, situational, search and hierarchical.

There is a great variety of information that may be adapted for the previous application as well as additional information service embodiments that may include the features described herein, for example, sports information; maritime information (for example, tide, winds, water, air temperatures, moon, boating conditions); outdoor recreation information (for example ski conditions, fishing reports); pollen information; venue, event and/or reservation information (many varieties for example, travel-related, flight information, restaurant, theater, concert, golf tee times, etc.); financial information (from indices to stocks to funds to portfolios); horoscopes; system status as well as alarm/notification based messaging and/or instruction (such messaging may be associated with the following sources: appliances; sensors; environmental, security, medical, or health apparatuses or systems, Homeland Security status indicators or bulletins); messaging services (for example, email, voice mail, instant messaging, etc.); digital pictures; video frames (for example, professional and amateur movies and/or trailers); traffic reports; weather (including multi-location weather information); community news and activities (this includes a variety of communities, for example, business/industry groups, alumni, affinity organizations, social network sites, etc.); calendar information; contact information; classifieds information; lifetime milestone information (for example, birthdays, anniversaries, weddings, graduations, religious milestones, etc.), product and services information; advertising information (for example, user-defined selective store, product, sale announcements, or electronic coupon announcements); and municipal, state and federal services information.

Another example of a telephonic-based application may account for a user converting an advertisement for a pizza via his/her cell phone, text messaging device or other communications device by conveniently ordering the pizza by utilizing the system's content codes and the telephonic enhancements. For example, the user, upon viewing or listening to an ad wherein the ad may incent the user to place an order within a certain time period, may place a call to, for example, the server port associated with the advertisement and/or media provider promoting the ad and/or the system. Upon the capture of the user's ANI or device identifier, the server may generate a program to search for the user's profile to perform at least one of a variety of functions, such as, for example, from crediting the user's account profile for placing another order to tabulating a rewards point promotion. One of the server program functions for recording the ANI and/or retrieving the profile is to confirm the user's location for a delivery and generating a program activation for a participating franchise locator. Depending on the user device, the user may also input or activate GPS coordinate inputs or the device may automatically transmit the inputs to facilitate the delivery at a designated location. Depending on the user's profile and/or sponsor options, the server may perform a range of functions, such as, for example, from initiating a call to the regional franchise and bridging the user on the call to performing an instant messaging interaction to text the order.

The server may also provide transaction services associated with the pizza ad, wherein the server program user profile may have a credit card and/or debit account that debits each transaction with the respective account card, pizza franchise loyalty credit, and/or record, etc. The account record user profile may comprise limits and other security related features, as well as support a variety of marketing services.

Some of the system embodiments described herein account for a variety of personalized or converted content adaptations which may be in device-based and/or web-based embodiments to support a variety of utilities for the end user and a number of other parties associated with converting content or utilizing it more effectively for their respective purposes. One of the primary utilities of some system adaptation embodiments is to facilitate user content engagement out of a variety of media and other sources and facilitate the procurement of gifts, products and services or better engagement with products and services. Another primary utility of the system is to provide targeted information to designated parties through more effective methods and systems.

The user device enhancements adapted for the system may be provided through software and device configurations that comprise a variety of communications technologies or protocols, device adjuncts, and the associated electronics, memory, processing and power means.

In an exemplary device embodiment comprising software adaptations, the software may reside in a menu and associated program that may comprise server addresses or port telephone or text numbers/characters, content identifier code tables, local area networked device address tables as well as command tables that may be associated with a variety of networked components such as, for example, portable devices, display devices, audio devices, web servers, content or media appliances (e.g. radio, television, etc.) and/or combinations thereof.

One example of a software and device/server/appliance integration program may be in system implementations that support a personalized radio media application. The system may utilize the enhanced radio appliance noted in the radio media section, wherein the appliance and a cell phone or portable device may comprise a device to device communications means, such as, for example, Bluetooth or ZigBee. In addition or alternatively, the cell phone/portable device may comprise OLED encapsulated button keypads wherein the keypads may display a series of station names or call signs (for example, “WEEI”, “WFAN”, “WCBS”, etc.) when the device is in a certain mode such as a personalized content conversion mode. In yet another alternative, the conversion mode may display a listing of the call signs in alphabetical or most frequently used order, wherein upon the user's interest in engaging a conversion, the conversion may be performed by either voice messaging or scrolling the device cursor over the entry and depressing the call sign. In yet another example of the functionality associated with the system, the OLED keypads or touchscreen may display certain functions when the device may be in an interactive mode with the server or adapted radio appliance in performing the personalized media enhancement functions. The functions may also display interactive sequences via touch screen frames/commands.

In the latter example of an interactive mode setting, a system radio appliance may receive a code embedded in a respective radio broadcast transmission wherein the code may comprise, for example, a communications address associated with converting the respective radio program content and advertising. The communications address may comprise, at least one of, a telephone number, a messaging address (for example, a SMS code), a URL address string, a server address, and a DNS address. The code may also comprise a key word, a key term, a numeric sequence, an alpha sequence, a special character sequence and combinations thereof. It is to be appreciated that at least one system embodiment may comprise at least a bi-lingual transmission code word(s) transmission set. The code may also comprise at least one of a variety of program operation settings for a receiving and/or networked device, wherein the respective setting may activate a certain type of call-out or communication response mode, such as a text-only mode, or a text-preference mode.

Upon the receipt of the transmission code, the respective radio appliance may extract and communicate the preceding code components to the networked communications device or, for example, mobile phone. Upon the receipt of the communication code from the adapted radio appliance, the mobile phone may active an interactive mode program, wherein the communications address and keyword information, such as a telephone number is flashed or name and telephone number and a respective keyword or term is displayed on the respective mobile phone display. As the program content and advertising changes, so does the respective information and, for example, accompanying media, on the mobile display.

Depending on the functions associated with the adapted devices, the respective code content may be presented to the system user in a variety of forms, for example, a commuter may chose to not look at a device display while driving and announce a voice command to hear a title of a song that is playing on the radio. Alternately, the user may enunciate a command, such as, for example, “Call”, or hit a button on his/her phone or networked radio to respond to a respective advertisement or other content of interest. The communications device may comprise various display embodiments and modes, for example, in addition to what is described herein, the device may comprise mobile icon interfaces, such as for example, zoomable user interface (ZUI) tiles that feature the respective program content and/or code.

As device and network technologies continue to enhance user experiences, these respective enhancements may be incorporated in the variety of embodiments associated with the system.

Media Streamer Integrations:

Media streaming devices (or “media streamers”) can use the system's web integration functions for the use and measurement of media tagging, call to operator, or purchase functions. The following are examples of some media streamer functions.

Streamer Tagging:

Tagging media streamed content may be achieved in various ways, including: upon activating a media streamer, such as, for example, hitting a “Listen (or) Watch Live” button or banner on a media web site, a cookie is passed. When the user is interested in tagging the respective streamed media content (such as, for example, a “TagNow” button on the streamer), where the tag creates a URL and associated URL parameters account for or referencing identifiers of the media player program, segment, player frame, and associated advertising (on media stream as well as banners).

Streamer Call to Operator:

Call to operator functionality and measurement may be implemented, for example, using: 1) click to call integration on the streamer (for response to audio or video stream advertising) or streamer banner advertisement; or 2) the method of publishing a measurable 800 or telephone number, measured directly by the system, where the 800 number terminates in a bridged gateway of the system platform, that captures the ANI of the user device, automatically bridges the call to the respective advertiser call center, and captures measurement data such as the time, length, user ANI, and other parameters associated with the call (which, for example, may be integrated with the call center).

Examples of click to call integrations include the automatic provision of the user's preferred reach number for a bridged call function between the user and other party (for example, an advertiser). One of the techniques for automatically providing a preferred reach number is via a registration process where the user may opt to provide his/her telephone number for click to call bridged functions associated with media provider partners, such as, for example, TagNow Media partners. Click to call functions from the streamer may also be generated by a default setting associated with a Voice Over IP software application that becomes activated upon the user activation of a Click to Call function on the streamer or a respective streamer banner. Both of these click to call functions and associated call parameters are also measurable.

Accounting for publishing a measurable telephone number that is bridged into the system provides the ability to measure response potentially back to the respective user (or at least user category) who listened or viewed the respective ad. Registered users of the tagging system or media web site may opt to provide their telephone or mobile numbers for a variety of reasons and users. In the likelihood that the user originates the phone call from his/her registered number, that respective user streaming session and interaction can be measured from all possible touch points—including purchase.

Streamer Item Procurement:

The system can also include a procurement function that is activated by the user either by the user's engagement of a purchase URL and URL parameter or widget function of the streamer or streamer banner. This function is available for both registered and non-registered users of the system.

Streamer Activations on Mobile Devices:

The above functions integrated on mobile devices present even more system features due to the use of device identifiers and parameters such as GPS or location-based pinging. For example, the streamer activation of a radio show may account for local advertising as a result of receiving or triangulating GPS coordinates via a carrier system.

Ad Placement Integration:

The aspects of the above system features, all being measurable, provide a way to classify audience members at a number of levels, including cookie integrations as permitted by law, as well as providing for the means for local advertising.

At a broad level, the measurements associated with aggregate audience categories as a result of the outputs of associated information from the invention system, provides for more targeted advertising.

Local advertising may be provided in the stream whether the streamer may be activated via a mobile device or a desktop PC. For example, the permissive cross domain passing of the user's cookie information may account for a zip code inquiry that maps to a streamer program that accounts for local advertising.

Many other implementations other than those described above are within the invention, which is defined by the following claims.

What is claimed is:

1. A method for providing information to a user, comprising:
associating a code with content that is available to multiple users;
storing data that associates information with the code;
receiving the code from a user input received over a communications channel from a communications device;
determining an identifier associated with the communications device from which the code was received; and
providing the information associated with the code for access on at least a portion of a web site provided based on an association between the user and the determined identifier.

2. The method of claim 1, wherein the medium over which the content is available to the multiple users is selected from the group consisting of print, television, radio, recorded video, and recorded audio.

3. The method of claim 1, wherein the information associated with the code comprises digital content associated with the content.

4. The method of claim 1, wherein providing the information associated with the code to the user comprises storing a digital content identifier that enables the information to be retrieved in response to a request from the user.

5. The method of claim 4, further comprising receiving a request from the user, retrieving the information according to the stored digital content identifier, and providing the information to the user as digital content.

6. The method of claim 5, wherein the request from the user is received over the communications channel over which the information associated with the code is provided to the user.

7. The method of claim 6, wherein the request from the user comprises data sent from a computer accessible to the user.

8. The method of claim 7, wherein the digital content is transmitted to the computer.

9. The method of claim 7, wherein the data sent from the computer comprises information selecting a link on a web page.

10. The method of claim 7, wherein the data sent from the computer comprises information from a cookie stored on the computer.

11. The method of claim 4, wherein the digital content identifier defines at least a portion of a web site associated with the user that includes the information.

12. The method of claim 4, wherein the digital content identifier comprises a hyperlink included in the web site associated with the user that links to the information.

13. The method of claim 4, wherein the digital content identifier comprises a link to the digital content and an indication of a media player in which the digital content is to be played.

14. The method of claim 13, wherein the digital content identifier further comprises an activation function associated with the presentation of the digital content on the media player.

15. The method of claim 1, wherein providing the information associated with the code to the user comprises storing a request for a person to contact the user to provide the information.

16. The method of claim 15, wherein the request includes contact information associated with the user.

17. The method of claim 16, wherein the contact information comprises the identifier associated with the communications device.

18. The method of claim 15, wherein the content comprises a real estate advertisement and the information associated with the code comprises real estate information.

19. The method of claim 1, wherein associating the code with the content comprises including the code within the content.

20. The method of claim 1, further comprising associating different respective codes with different content that is available to multiple users.

21. The method of claim 20, further comprising storing data that associates different respective information with different codes.

22. The method of claim 1, further comprising associating the same code with different content that is available to multiple users at different respective times and/or different respective locations.

23. The method of claim 22, wherein the time and/or location comprises at least one of time of day, day of week, city, zip code, global positioning system (GPS) coordinates, and event.

24. The method of claim 22, further comprising storing data that associates different respective information with the same code according to time and/or location at which the associated content was available.

25. The method of claim 24, wherein the information provided to the user is based on a correlation between the time of day at which the associated content was available and a time of day at which the user input was received.

26. The method of claim 24, wherein the information provided to the user is based on a location received from the device.

27. The method of claim 24, wherein the information provided to the user is based on a location determined based signals received from the device.

28. The method of claim 1, further comprising storing user profile information associated with the user.

29. The method of claim 28, wherein providing the information associated with the code to the user comprises providing information to at least one different user based on the user profile information.

30. The method of claim 29, wherein providing information to at least one different user based on the user profile information comprises providing the information based on an association between the user profile information associated with the user and user profile information associated with the different user.

31. The method of claim 28, wherein at least some of the user profile information is received from the user.

32. The method of claim 31, wherein the user profile information includes the identifier associated with the communications device.

33. The method of claim 31, further comprising providing at least one advertisement to the user in response to receiving the code.

34. The method of claim 33, wherein the advertisement is provided to the user based on the user profile information.

35. The method of claim 33, wherein the advertisement is provided to the user based on location information associated with the communications device.

36. The method of claim 31, further comprising receiving over the communications channel from the communications device information indicating which user profile of multiple user profiles includes the stored user profile information associated with the user.

37. The method of claim 31, wherein the user profile information includes instructions to process and store the information associated with the code in a designated manner for retrieval by the user.

38. The method of claim 31, wherein the instructions include processing and storing the information for retrieval as at least one of email, audio recording, video recording, voice mail, web content, SMS, MMS, instant message, podcast, and videocast.

39. The method of claim 1, further comprising initiating a transaction based on the association between the user and the determined identifier.

40. The method of claim 39, wherein the information associated with the code comprises information about the initiated transaction.

41. The method of claim 1, wherein the content comprises advertising.

42. The method of claim 41, wherein the content comprises a radio advertisement.

43. The method of claim 1, wherein the communications device comprises a mobile device.

44. The method of claim 43, wherein the communications device comprises a cell phone.

45. The method of claim 44, wherein the identifier associated with the communications device comprises a telephone number associated with the cell phone.

46. The method of claim 44, wherein receiving the code from the user input through the communications device comprises receiving the code over a telephone call initiated from the cell phone.

47. The method of claim 46, wherein the telephone call comprises a call to a telephone number associated with a medium over which the content was available to the user.

48. The method of claim 47, wherein the medium comprises an audio transmission medium and the telephone number associated with the medium comprises a telephone number associated with a provider from which the content was available.

49. The method of claim 47, wherein the medium comprises a video transmission medium and the telephone number associated with the medium comprises a telephone number associated with a provider from which the content was available.

50. The method of claim 47, wherein the medium comprises a print medium and the telephone number associated with the medium comprises a telephone number associated with a distributor from which the content was available

51. The method of claim 46, wherein the telephone call comprises a call to an operator.

52. The method of claim 1, further comprising recording an interaction with the user associated with the received code.

53. The method of claim 52, wherein recording the interaction comprises storing tracking data associated with the interaction.

54. The method of claim 53, further comprising filtering the tracking data.

55. A method for providing information to a user, comprising:
associating a code with content that is available to multiple users;
storing data that associates information with the code;
receiving the code over a communications channel from a communications device;
determining an identifier associated with the communications device from which the code was received; and
providing the information associated with the code to the user over a communications channel from a live person based on the determined identifier.

56. The method of claim 55, wherein the live person is associated with an entity from which the content is available.

57. The method of claim 55, further comprising recording an interaction with the user associated with the received code.

58. The method of claim 57, wherein recording the interaction comprises storing tracking data associated with the interaction.

59. The method of claim 58, further comprising filtering the tracking data.

60. A method for providing information to a user, comprising:
associating a code with content that is available to multiple users;
storing data that associates information with the code;
receiving the code and a command associated with the code over a communications channel from a communications device;
determining an identifier associated with the communications device from which the code was received; and
providing the information associated with the code to the user based on an association between the user and the determined identifier.

61. The method of claim 60, wherein the medium over which the content is available to the multiple users is selected from the group consisting of print, television, radio, and multimedia stream.

62. The method of claim 60, wherein the content available to the multiple users is provided to the multiple users in response to different respective requests from the multiple users.

63. The method of claim 60, wherein the content available to the multiple users is provided to the user over a communications channel that is the same as the communications channel over which the code was received.

64. The method of claim 60, wherein the content available to the multiple users is provided to the user over a communications channel that is different from the communications channel over which the code was received.

65. The method of claim 60, wherein the information associated with the code comprises digital content associated with the content.

66. The method of claim 60, wherein providing the information associated with the code to the user comprises storing a digital content identifier that enables the information to be retrieved in response to a request from the user.

67. The method of claim 66, further comprising receiving a request from the user, retrieving the information according to the stored digital content identifier, and providing the information to the user as digital content.

68. The method of claim 67, wherein the request from the user is received over a communications channel over which the information associated with the code is provided to the user.

69. The method of claim 68, wherein the request from the user comprises data sent from a computer accessible to the user.

70. The method of claim 69, wherein the digital content is transmitted to the computer.

71. The method of claim 69, wherein the data sent from the computer comprises information selecting a link on a web page.

72. The method of claim 69, wherein the data sent from the computer comprises information from a cookie stored on the computer.

73. The method of claim 66, wherein the digital content identifier defines at least a portion of a web site associated with the user that includes the information.

74. The method of claim 66, wherein the digital content identifier comprises a hyperlink included in the web site associated with the user that links to the information.

75. The method of claim 66, wherein the digital content identifier comprises a link to the digital content and an indication of a media player in which the digital content is to be played.

76. The method of claim 75, wherein the digital content identifier further comprises an activation function associated with the presentation of the digital content on the media player.

77. The method of claim 60, wherein the command indicates how the information associated with the code is to be processed.

78. The method of claim 77, wherein the command indicates a destination to which the information associated with the code is to be sent.

79. The method of claim 77, wherein the command indicates a category with which the information associated with the code is to be associated.

80. The method of claim 77, wherein the command indicates data to be sent to the device.

81. The method of claim 60, wherein providing the information associated with the code to the user comprises storing a request for a person to contact the user to provide the information.

82. The method of claim 81, wherein the request includes contact information associated with the user.

83. The method of claim 82, wherein the contact information comprises the identifier associated with the communications device.

84. The method of claim 81, wherein the content comprises a real estate advertisement and the information associated with the code comprises real estate information.

85. The method of claim 60, wherein associating the code with the content comprises including the code within the content.

86. The method of claim 60, further comprising associating different respective codes with different content that is available to multiple users.

87. The method of claim 86, further comprising storing data that associates different respective information with different codes.

88. The method of claim 60, further comprising associating the same code with different content that is available to multiple users at different respective times and/or different respective locations.

89. The method of claim 88, wherein the time and/or location comprises at least one of time of day, day of week, city, zip code, global positioning system (GPS) coordinates, and event.

90. The method of claim 88, further comprising storing data that associates different respective information with the same code according to time and/or location at which the associated content was available.

91. The method of claim 90, wherein the information provided to the user is based on a correlation between the time of day at which the associated content was available and a time of day at which the code was received.

92. The method of claim 90, wherein the information provided to the user is based on a location received from the device.

93. The method of claim 90, wherein the information provided to the user is based on a location determined based signals received from the device.

94. The method of claim 60, further comprising storing user profile information associated with the user.

95. The method of claim 94, wherein providing the information associated with the code to the user comprises providing information to at least one different user based on the user profile information.

96. The method of claim 95, wherein providing information to at least one different user based on the user profile information comprises providing the information based on an association between the user profile information associated with the user and user profile information associated with the different user.

97. The method of claim 94, wherein at least some of the user profile information being received from the user.

98. The method of claim 97, wherein the user profile information includes the identifier associated with the communications device.

99. The method of claim 97, further comprising providing at least one advertisement to the user in response to receiving the code.

100. The method of claim 99, wherein the advertisement is provided to the user based on the user profile information.

101. The method of claim 99, wherein the advertisement is provided to the user based on the location information associated with the communications device.

102. The method of claim 97, further comprising receiving over the communications channel from the communications device information indicating which user profile of multiple user profiles includes the stored user profile information associated with the user.

103. The method of claim 97, wherein the user profile information includes instructions to process and store the information associated with the code in a designated manner for retrieval by the user.

104. The method of claim 97, wherein the instructions include processing and storing the information for retrieval as at least one of email, audio recording, video recording, voice mail, web content, SMS, MMS, instant message, podcast, and videocast.

105. The method of claim 60, further comprising initiating a transaction based on the association between the user and the determined identifier.

106. The method of claim 105, wherein the information associated with the code comprises information about the initiated transaction.

107. The method of claim 60, wherein the content comprises advertising.

108. The method of claim 107, wherein the content comprises a radio advertisement.

109. The method of claim 60, wherein the communications device comprises a mobile device.

110. The method of claim 109, wherein the communications device comprises a cell phone.

111. The method of claim 110, wherein the identifier associated with the communications device comprises a telephone number associated with the cell phone.

112. The method of claim 110, receiving the code and the command associated with the code comprises receiving the code over a telephone call initiated from the cell phone.

113. The method of claim 112, wherein the telephone call comprises a call to a telephone number associated with a medium over which the content was available to the user.

114. The method of claim 113, wherein the medium comprises an audio transmission medium and the telephone number associated with the medium comprises a telephone number associated with a provider from which the content was available.

115. The method of claim 113, wherein the medium comprises a video transmission medium and the telephone number associated with the medium comprises a telephone number associated with a provider from which the content was available.

116. The method of claim 113, wherein the medium comprises a print medium and the telephone number associated with the medium comprises a telephone number associated with a distributor from which the content was available

117. The method of claim 112, wherein the telephone call comprises a call to an operator.

118. The method of claim 60, further comprising recording an interaction with the user associated with the received code.

119. The method of claim 118, wherein recording the interaction comprises storing tracking data associated with the interaction.

120. The method of claim 119, further comprising filtering the tracking data.

121. A method for providing information to a user, comprising:
embedding a code within content that is available to multiple users;
storing data that associates information with the code;
receiving the content at a communications device and extracting the code from the content;
receiving the code over a communications channel from the communications device; and
providing the information associated with the code to the user.

122. The method of claim 121, wherein the communications device has a network connection.

123. The method of claim 121, wherein the communications device is connected to a device with a network connection.

124. The method of claim 121, wherein providing the information associated with the code to the user comprises providing the information based on an association between the user and the determined identifier.

125. The method of claim 121, wherein the communications channel is based on the embedded code.

126. The method of claim 125, wherein the communications channel is based on the embedded code and a command provided from the communications device.

127. The method of claim 121, wherein the code is associated with a perceptible prompt.

128. The method of claim 127, wherein the code is associated with a visually perceptible prompt that is presented on a screen.

129. The method of claim 127, wherein the code is associated with an audibly perceptible prompt.

130. The method of claim 127, wherein the prompt is associated with a command.

131. The method of claim 130, wherein the command corresponds to a function that is selected from the group consisting of: call, tag, buy, post, and send.

132. The method of claim 121, wherein the information associated with the code is provided by a live person.

133. The method of claim 121, wherein the information associated with the code comprises a digital media version of the content.

134. The method of claim 121, wherein the content comprises audio content.

135. The method of claim 134, wherein the code is embedded within inaudible portions of the audio content.

136. The method of claim 121, wherein the content comprises video content.

137. The method of claim 121, wherein the code is embedded within portions of the content that are not perceptible when presented to a user.

138. The method of claim 121, wherein the code comprises at least one communications address.

139. The method of claim 138, wherein the communications address is selected from the group consisting of a telephone number, a URL, a messaging domain code, a server address, and a DNS address.

140. The method of claim 139, wherein the messaging domain code is selected from the group consisting of a SMS domain, a voice SMS domain, a MMS domain, and an instant messaging domain.

141. The method of claim 121, wherein the code comprises a code selected from the group consisting of a key word, a key term, a numeric sequence, an alpha sequence, a special character sequence and combinations thereof.

142. The method of claim 121, wherein the code key word is in more than one language.

143. The method of claim 121, further comprising extracting the code from the content at the communications device.

144. The method of claim 121, wherein the extracting is initiated by the user.

145. A method for providing information to a user, comprising:
associating a code with content in a database;
receiving the code over a communications channel from a communications device;
determining an identifier associated with the communications device from which the code was received; and
providing content from the database associated with the code to the user based on an association between the user and the determined identifier.

146. The method of claim 145, wherein the code identifies a person and the content from the database associated with the code comprises contact information for the identified person.

147. The method of claim 146, wherein providing the content from the database associated with the code to the user comprises storing the contact information in association with an account accessible to the user.

148. The method of claim 145, wherein the communications device comprises a transmitter that is connected to a sensor.

149. The method of claim 148, wherein the sensor is selected from the group consisting of: an accelerometer, a biosensor, an environmental sensor, an olfactory sensor, an optical sensor, a motion detector, and a circuit sensor.

150. The method of claim 145, wherein the communications device comprises a transmitter that is connected to a reader.

151. The method of claim 150, wherein the reader is selected from the group consisting of: an RFID reader, an optical character reader, a scanner, and a barcode reader.

152. The method of claim 145, wherein the content from the database is associated with a military vehicle or a unit assigned to a military vehicle.

153. The method of claim 152, further comprising recording transmission of the code over the communications channel from the communications device.

154. The method of claim 153, further comprising recording a location of the communications device at the time the transmission is recorded.

155. The method of claim 153, wherein recording the transmission comprises recording a date and time of the transmission.

156. The method of claim 153, wherein the identifier associated with the communications device from which the code was received comprises a location of the communications device at the time of the transmission.

157. The method of claim 153, wherein the identifier associated with the communications device from which the code was received comprises a date and time of the transmission.

158. The method of claim 145, wherein the communications device has a unique network address.

159. The method of claim 158, wherein the identifier associated with the communications device from which the code was received comprises the network address of the communications device.

160. A system for providing information to a user, comprising:
a server storing data that associates different codes with respective content that is available to multiple users; and
a communications device configured to transmit a code received from user input over a first communications channel;
wherein the server is configured to determine an identifier associated with the communications device from which the code was received, and to provide the information associated with the code over a second communications channel that is different from the first communications channel for access on at least a portion of a web site provided based on an association between the user and the determined identifier.
